(19) United States
(12) Patent Application Publication
(10) Pub. No.: US 2007/0043730 A1
(43) Pub. Date: Feb. 22, 2007

(54) Data retrieval scheme

(76) Inventor: David Wisely, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 10/573,151

(22) PCT Filed: Sep. 29, 2004
(86) PCT No.: PCT/GB04/04160

§ 371 Date: Mar. 23, 2006

(30) Foreign Application Priority Data
Sep. 30, 2003 (GB) 0322880.6

(51) Int. Cl. G06F 17/30

(52) U.S. Cl. 707/10

(57) ABSTRACT

A method of purchasing an item, the method enabling a user to search for information on the cost of an item on a distributed computer system, the method comprising: generating a search request for the item at a user terminal; modifying the search request to indicate at least one user preference; forwarding the search request to a server adapted to retrieve data from the distributed computer system, the server adapted to provide a search result to a user terminal selected in accordance with a predetermined user preference dependent on the extent to which the search result conforms with the search request, whereby the user is able to purchase the item at the cost informed by the search result.

This invention relates to a data retrieval scheme, in particular for retrieving data comprising pricing and/or price-related information. The data retrieval scheme particularly but not exclusively is incorporated into a purchasing scheme which enables a user to purchase an item over a communications system.

The data retrieval scheme and the purchasing scheme into which it is incorporated enables a user to purchase an item which is returned as a search result generated in accordance with the search system described in the inventor's co-pending patent application “SEARCH SYSTEM AND METHOD” whose contents are hereby incorporated by reference.

Currently, when a person performs a search using a conventional search engine over a communications network such as, for example, the internet, a search can retrieve data comprising pricing and/or price-related information for a specific item which may be influenced by the vendors. For example, a vendor may wish to undercut other vendors to bias the user's choice towards their site. However, in general, a user searching for an item over the internet using a conventional search engine such as Google™ for example, would not want to have to provide additional information specific to the user when they request the search.

However, the characteristics and/or identity of the user may affect the type of item or the cost of the item or the terms under which an item is offered. For example, vendors may wish to adjust the price if a user has a poor credit history the price of an item to be provided may differ from the price to be charged to a more credit-worthy user. A poor-credit-history user who seeks a particular item may be offered a product which is cheaper than a more luxurious or more expensive item which would be of interest to a more affluent user. Similarly, if a user is searching for an item related to a specific topic, and has purchased items from a particular site repeatedly, the search engine may be optimised to focus on items of that type from that site when the user enters their search request.

Such searches are not limited to purely financial fields. For example, travel or medical insurance searches may be completely irrelevant to certain individuals. For example, if someone searches generally for medical insurance, they may be able to enter a particular site offering a comparison of different insurance products, and there they will have to indicate that they have a heart condition or other debilitating condition which may affect the terms offered. However, the user may have other conditions which might affect the relevance of the products offered. These conditions may be too numerous or too complex for the user to wish to include in their search request. Nonetheless such information is required as it can dramatically affect what insurance products are available and the terms on which they are offered to the user. Consequently, a user may believe they have purchased suitable medical cover on-line, but they discover subsequently when they are sent the insurance policy terms that in fact they may require supplementary cover or must increase the insurance premium.

Another typical example, is if a user wished to search for car insurance. The user must enter with the search any membership information regarding bodies such as who the person's employer is or if they are a member of an automobile club or association if they want to receive information which reflects the discounts which may be available. Further, if a person simply wishes to purchase an item which is below a specified price, the person has to review the search results and manually enter their details with the appropriate site if such a service is offered on line (or if not contact the prospective vendor in some appropriate manner (for example, either call, fax, email or write a letter to them) and provide their financial and address details before the item (which may be a service) can be purchased.

The above examples indicate how tedious and time-consuming performing a search can be in cases where the search results returned are not generic to all potential persons seeking to retrieve the information.

In addition, incentive schemes for online purchasers in the same manner in which chain stores are currently able to offer incentive schemes to their customers cannot be implemented in an easy or straightforward manner using purchasing schemes such as those known in the art.

The invention seeks to mitigate and/or obviate the disadvantageous in the prior art by providing a data retrieval scheme in which data can be provided in a form to the user enabling the user to take a further action directly on the data retrieved, such as the purchase of an item (which may comprise a product (virtual or real) or service (virtual or real). The data retrieval system uses a search system to locate an item by providing additional information on the purchaser by including user preferences information in the search request.

Advantageously, one aspect of the invention is able to automatically provide additional information on the user which enables a user to purchase an item identified by the search system at a cost which is modified by a proxy server mediating between the user and a search server.

Advantageously, the invention uses a protocol which enables a user to be associated with a permanent identity which may be associated with a static or dynamic address, for example, a session initiation protocol (SIP) identity. This enables the user to retrieve data from a distributed computer system to enable a search result to be sent to the user even if the initial search session has terminated. The invention also enables a user to purchase an item even if the user is not in communication with the SIP proxy server at the time the item is purchased.

This invention relates to an automatic purchase scheme which uses the search system and method of searching described in the inventor's copending patent application “SEARCH SYSTEM AND METHOD” which allows data to be searched for and retrieved over a distributed computer system. The search system and method use a protocol which enables a user to be associated with a permanent identity which can be mapped to an address (which may be either static or dynamic). In particularly, but not exclusively, the search system and method uses a permanent identity such as a Session Initiation Protocol (SIP) User Resource Identifier (URI), to retrieve data from a distributed computer system to enable a search result to be sent to the user even if the initial search session has terminated.

Search systems for retrieving data (i.e., information) from distributed computer systems such as the Internet are known to have certain limitations. Internet search sites, for example Google™, are configured to return results within a time limit which appears almost instantaneous to the user of the search site.

Consider the case where a person, enters a highly complex search request on such a search site, for example, a search request involving perhaps a complex string of key words and Boolean operators. If the search request is sufficiently complex then conventional search sites would not be able to return any results complying with the search query criteria in the short period of time which is usually set for determining and displaying the search results.

A search entered on a conventional search site usually has to generate at least one search result within a specific period of time or the search site will display a negative search result to the user of the search engine. There is no mechanism to accommodate complex searches or to provide a search storage facility so that a user may in fact “log-off” the search site and retrieve their search results at a later point in time. The users of such search sites are effectively limited to the length of session that they can have with the search “server”.

Other limitations include the user of a search site being unable to select where the search results are sent or how the search results are to be formatted and presented. For example, a user may enter a search request on a personal computer type terminal having a conventional display attached. However, the user may not want the results until a few hours have passed so that complex information can be retrieved and they may want the results to be displayed on their mobile phone.

Another limitation is that only restricted preferences are currently stored for users normally on the user's terminal or on the search “server”. For example, preferences stored on the user's terminal can be provided by Internet Explorer 6 (IE6) predictive typing, stored lists past sites or content filters. Yahoo portal customisation is an example of the latter. However if one were to search for Manchester City and want information on the city itself and not the football club of the same name, it would be impossible to record a negative preference such as “AND NOT football” which would be retained for parsing future search results.

Another limitation is that current search methods do not support providing results in a variety of different formats. For example, current search methods do not enable a search engine to send an Email, phone a hotel and fill in a web form automatically. This is because search methods known in the art do not have the deeper understanding of the search preferences which would be required to implement such a sophisticated search method, as known search methods have no mechanism for understanding the context of the search, for example, —where the user is, the time, the preferences, etc, nor do current search methods offer a permanent state storage.

The present invention seeks to mitigate and/or obviate the above limitations known in the art by providing a search system and method which supports complex search queries being entered and which modifies searches according to user preferences. User preferences are also used to perform supplementary searches to obtain more detailed information and to designate end terminals where search results are to be sent.

### SUMMARY STATEMENTS OF THE INVENTION AND ADVANTAGES

A first aspect of the invention seeks to provide a method of purchasing an item, the method enabling a user to search for information on the cost of an item on a distributed computer system, the method comprising: generating a search request for the item at a user terminal; modifying the search request to indicate at least one user preference; forwarding the search request to a server adapted to retrieve data from the distributed computer system, the server adapted to provide a search result to a user terminal selected in accordance with a predetermined user preference dependent on the extent to which the search result conforms with the search request, whereby the user is able to purchase the item at the cost informed by the search result.

A user preference may include financial information personal to the user and at least one criteria which a search result must conform which initiates the automatic purchase of the item prior to the user being informed of the search result.

The search result may be provided in a medium and format selected by the user for a user terminal to which the search result is to be forwarded.

The user terminal may be selected according to the extent to which the search result conforms with the search request.

A second aspect of the invention seeks to provide a method of searching for data to be retrieved from a distributed computer system, the data including an item and associated cost information, the distributed computer system comprising at least one user terminal capable of communicating with a proxy server, the proxy server being capable of communicating with at least one other server capable of retrieving information from the distributed computer system, the user terminal being adapted to be operable by a user who is registered with the proxy server with a unique permanent user identity associated with one or more static or dynamic addresses, the user identity being associated with a set of user preferences, the method comprising the steps of: generating a search request at one of said at least one user terminals, the search request indicating at least one search criterion to be met by the data to be retrieved; sending a search request message encapsulating the search request to the proxy server; associating the search request message with a unique search number associated with the user's unique identity; forwarding the search request message to at least one search server arranged to process the received search request message; performing a search according to the encapsulated search request; sending a search result encapsulated in a search result message to the proxy server; de-encapsulating the search result message; processing the search result according to the set of user preferences; selecting one of said at least one user terminals according to the set of user preferences; and sending an search result message encapsulating the processed search result to said at least one selected user terminal.

The method according to the second aspect may further include the step of the proxy server purchasing the item at the cost indicated by the search result and modifying the search result to indicate the item has been already purchased, if at least one predetermined user preference indicates personal financial information of the user which enables the purchase transaction to be completed by the proxy server, the proxy server being configured to automatically purchase an item at a designated cost if at least one user preference indicates that an automatic purchase can occur if the search result meets at least one predetermined search criterion.

The distributed computer system may support the session initiation protocol (SIP), and wherein the user terminal is a SIP registered terminal, the proxy server is a SIP proxy server and the user is registered at the proxy server with a unique SIP address.

The search result message may be a SIP message which is sent to the user at an address determined by the SIP proxy server to be the current location of the user who requested the search. The search result SIP message may be sent to a plurality of addresses associated with the user's registered SIP identity. The search result SIP message may be sent to an address associated with a different user terminal than the user terminal operated by the user to send the search request to the SIP proxy server. The user terminal may be a mobile device.

The set of user preferences may comprise a formatting user preference which indicates how the search result should be formatted. The set of user preferences may comprise a plurality of formatting user preferences, each formatting user preference being associated with a type of user terminal.

The method of the first or second aspects may further comprise the step of the proxy server modifying the set of at least one search criterion according to said set of user preferences. At least one user preference may indicate a scheme to which the user has subscribed which may modify the cost of an item returned by the search. The method according to the first or second aspects may further comprise the step of the proxy server modifying the search result according to a set of user preferences. The proxy server software may modify the search result by modifying the cost of an item returned according to a pricing scheme to which the user has subscribed. The proxy server software may modify the search result by modifying the cost of an item returned according to a pricing scheme provided by the proxy server software. The at least one search server to which said search request message is forwarded to by the proxy server may be determined by the proxy server in accordance with said set of at least one user preferences.

The proxy server may modify the search result received to identify an address to which the search request can be forwarded to in the form of an electronic message. For example, an electronic message such as an electronic mail message, a small message service (SMS) message, or a multi-media mobile message, etc. The proxy server may process the returned search result to remove at least one result which is indicated by at least one user preference as not relevant to the user's listed interests. The proxy server may process the returned search result to modify any returned cost value for an item indicated by the search according to a discount scheme to which the identity of the user is associated. The proxy server may process the search result to prioritise the delivery of at least one item listed by the search result to the user in accordance with the extent to which said at least one item conforms with the set of at least one search criterion.

The proxy server may alert the user to a search result by encapsulating the search result in a small message service SMS message which is sent to the user over a communications network. The search request may be generated by the user terminal modifying a previously stored search request in accordance with an updated set of at least one search criterion. The set of at least one user preference may specify a maximum time limit for the search results to be generated. The distributed computer system may be connected over a communications network. For example, a communications network which includes the internet, a PSTN, and which is capable of wireless and/or wireless connections with end terminals.

The session during which software provided on the user terminal interfaces with software provided on the proxy server to send the proxy server the search request message may be terminated when the proxy server sends the search result message to the user.

A third aspect of the invention seeks to provide a user terminal arranged to be operable by a user for use in generating a search request according to a method aspect of the invention.

A fourth aspect of the invention seeks to provide a proxy server arranged to receive a search request message from a user terminal according to the third aspect, the proxy server being arranged to be used in a method aspect of the invention.

A fifth aspect of the invention seeks to provide a suite of computer programs arranged to implement one or more steps in a method aspect of the invention, the suite of computers being provided on the distributed computer system. The computer programs may be implemented in software and/or hardware.

A sixth aspect of the invention seeks to provide a signal carrying a search request generated by a method aspect of the invention over a communications network comprising the distributed computer system.

A seventh aspect of the invention seeks to provide a signal carrying a search result generated by a method aspect of the invention over a communications network comprising the distributed computer system.

An eighth aspect of the invention seeks to provide a communications network arranged to communicate a signal aspect of the invention.

A ninth aspect of the invention seeks to provide a method of providing an item at a discounted cost to a user over a communication network comprising a distributed computer system, the method comprising performing a search for the item and associated cost information according to any one of claims 1 to 6, wherein the proxy server automatically provides the server software at a site indicated in the search result as able to provide the item requested by the search request with information derived from the user's preferences, the information including: sufficient financial information to enable the user to purchase the item; sufficient address information to enable the item to be sent to an address designated by the user.

An item to be purchased may be automatically provided with a postal address by the SIP server using user preference information which provides personal information on the user's address. This enables the item purchased to be sent to a postal address.

A ninth aspect of the invention seeks to provide a discount purchase scheme in which a user is provided with an item using a method aspect of the invention, the method further comprising discounting the cost of the item returned by the search by a predetermined amount in accordance with a discount rule determined by the proxy server.

When an item is purchased a user preference may be updated to reflect a predetermined number of points which can be indicated by the user in at least one future search request for an item and associated cost information.

The points indicated by the user preference may generate a discount in the cost of an item indicated by a search result which at least partially conforms with the future search request.

A tenth aspect of the invention seeks to provide a method enabling a user to search for information on the cost of an item on a distributed computer system, the distributed computer system including an end terminal of the user, a proxy server, and at least one information source, the method comprising: generating a search request for the item at the user terminal; modifying the search request to indicate at least one user preference; forwarding the search request from the proxy server, the proxy server being adapted to retrieve data from one or more of said data sources, the proxy server being adapted to process a search result received from a data source and provide additional information to further interrogate a data source identified by said search result to receive a second search result, the proxy server being adapted to provide the second search result to a user terminal selected in accordance with a predetermined user preference dependent on the extent to which the search result conforms with the search request, whereby the user is able to purchase the item at the cost informed by the search result.

The SIP search software may optimise the purchase of complex items requested by prompting the user for additional parameters which relate to the purchase. A user may enter a search request and the SIP server modifies the terms in the search request to optimise the purchase price of an item. The SIP server may provide a notification of the results to a user end terminal and the user increases the bandwidth available to receive a search result following said notification. This enables a user to move into a higher bandwidth environment, such as a hotspot for WI-FI in a wireless LAN environment.

A search result could be forwarded by the proxy server to a data source by the proxy server sending an electronic mail message to an electronic mailing list associated with the search result, or by filling out a web page (e.g. for insurance quote) automatically. The data source may not be accessible via another server but could be accessible via instead an IP-PSTN gateway, for example, if the proxy server uses automatic speech generation and recognition technology to phone up a hotel and actually request a price using some conversion means to convert the text version of the search request into a spoken version. The data source may comprises a server and an associated search engine. Thus, the invention enables the user to terminate the session with the search server prior to the search results being generated, which enables more complex search requests to be processed.

The invention also enables the user to receive search results more rapidly if the result is sufficiently conforming with the user preferences to be determined as a high priority. In this way, the user is provided with more relevant results faster. The user identity may be associated with one or more static and/or dynamic addresses. Examples of static/dynamic addresses include—an E164 address (please explain what this is/means), an IP address, a telephone number for a facsimile, a pager number. Examples of a data source include any source of information which is available via the distributed computer system. The data source is preferably running the special search software (module #3) for greater functionality and better optimisation. In alternative embodiments the data source may comprise a web page.

The search result message may encapsulate the processed search result. Alternatively, the search result message may provide a key to enable a user retrieve the processed search result. For example, an SMS could be sent to alert a user of a particular search result having being obtained and provide the user with a key (e.g. a code or encrypted message) which enables the user to retrieve video from a store. It is envisaged that such “alerts” will be very useful where a search result indicates a file has been located as it would enable the user to connect to the proxy server using a suitable bandwidth connection.

The invention supports SMS messaging to alert users to search results and providing a user with a key to enable the user to retrieve a file via a high bandwidth connection such as a WLAN. For example, if a video clip was located, a user might wish to access this from a WLAN because the file is too big to view/download over a dial-up bandwidth connection.

The invention also enables the search process to be performed more efficiently by including additional information provided by the user preferences in the search request and/or using additional information provided by the user preferences to remove less relevant search results which are returned to the enhanced SIP server prior to these results being forwarded to the user. The invention thus enhances the RFC (please defined this) functionality of the server software over the normal search software which a server may have.

The search can be forwarded to the most appropriate user end terminal for the content of the search result. The search can also be forwarded to the user end terminal which the user is operating at the time the search result is forwarded. The SIP proxy server is able to store results which are received when an appropriate user end terminal cannot be identified as one which is being operated by the user. The SIP proxy server may then modify at least one search result or generate another form of notification to alert the user to the search result and to indicate to the user how the user may retrieve the search result.

Another aspect of the invention seeks to provide a proxy server which is arranged to receive a search request message from a user end terminal aspect of the invention, the proxy server being arranged to be used in a method aspect of the invention.

The preferred features of the invention as set out by accompanying the dependent claims may be combined with any of the aspects of the invention as set out by the independent claims in any manner which is apparent to those skilled in the art.

Specific embodiments of the invention will now be described by way of example only and with reference to the accompanying drawings, in which:

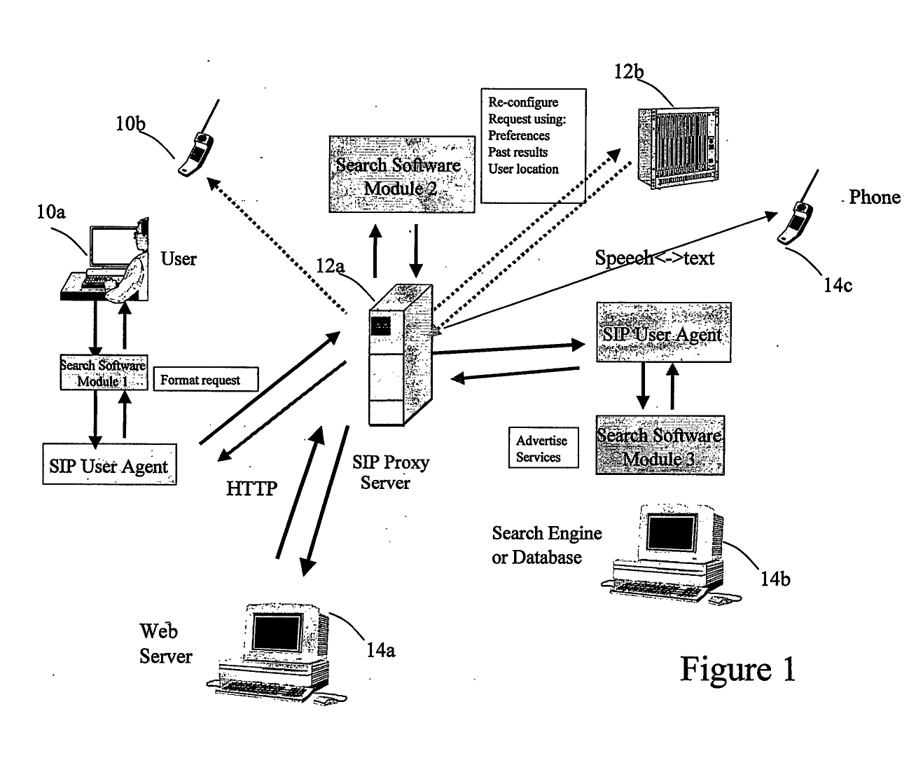

FIG. 1 shows schematically a SIP-supported data retrieval system according to an embodiment of the invention;

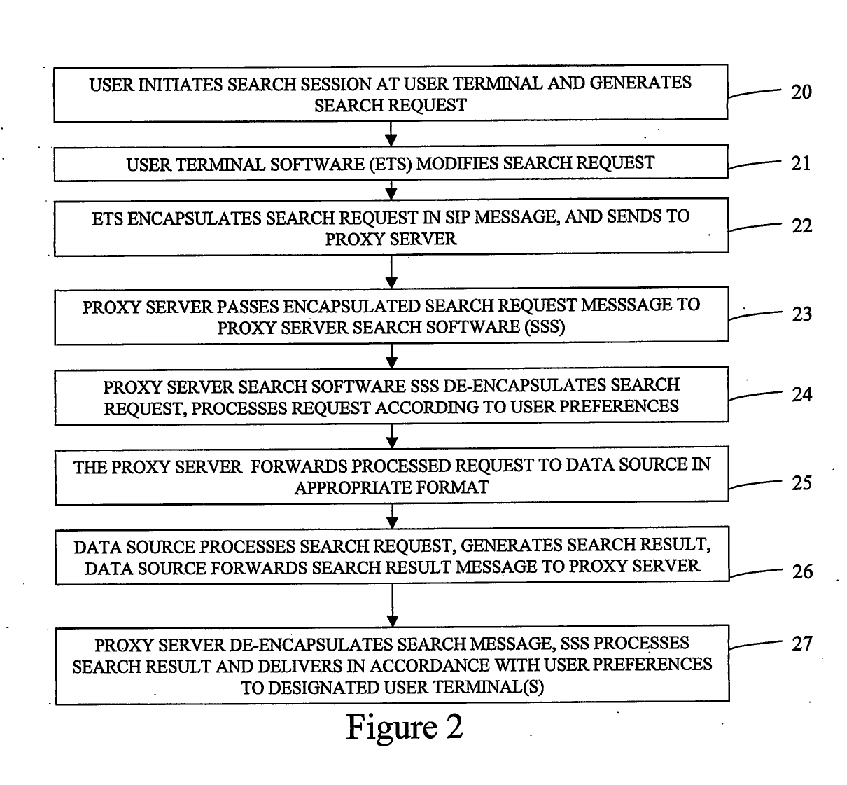

FIG. 2 is a flowchart showing schematically steps in a method of searching for data according to an embodiment of the invention;

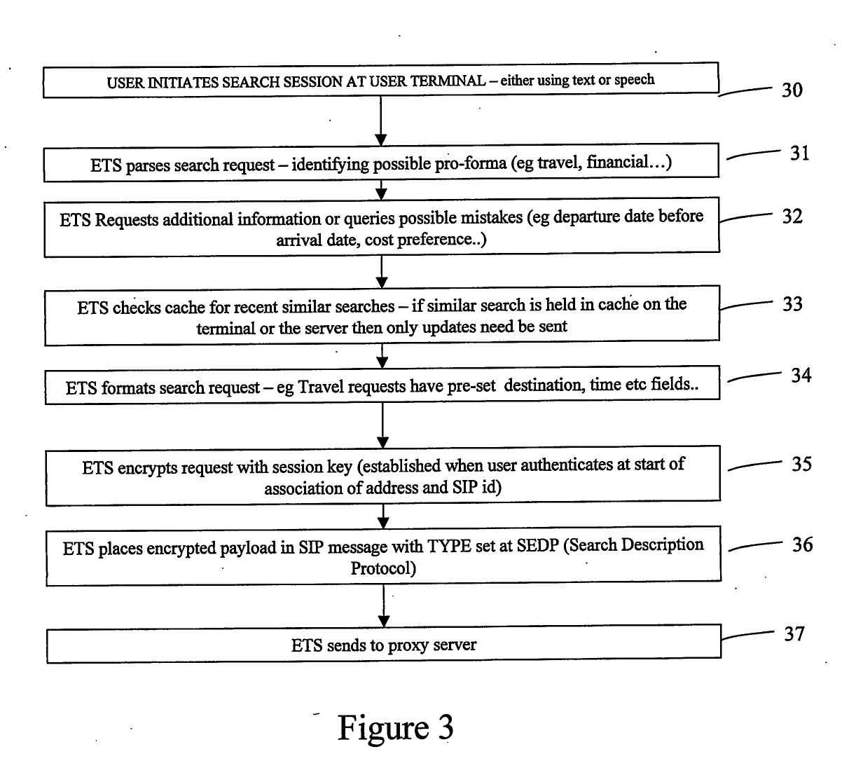

FIG. 3 shows steps which occur at an end user end terminal in a method of method of searching for data to be retrieved from a distributed computer system according to an embodiment of the invention;

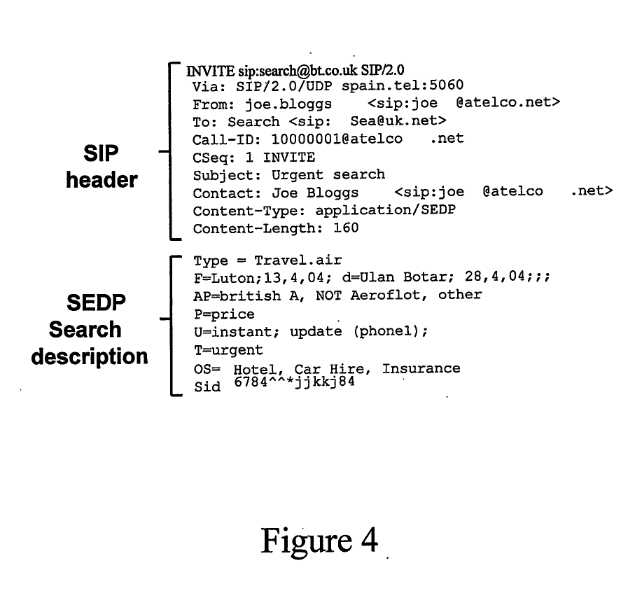

FIG. 4 shows schematically an example of the fields in a SIP header and Search Description Protocol according to the embodiment shown in FIG. 3;

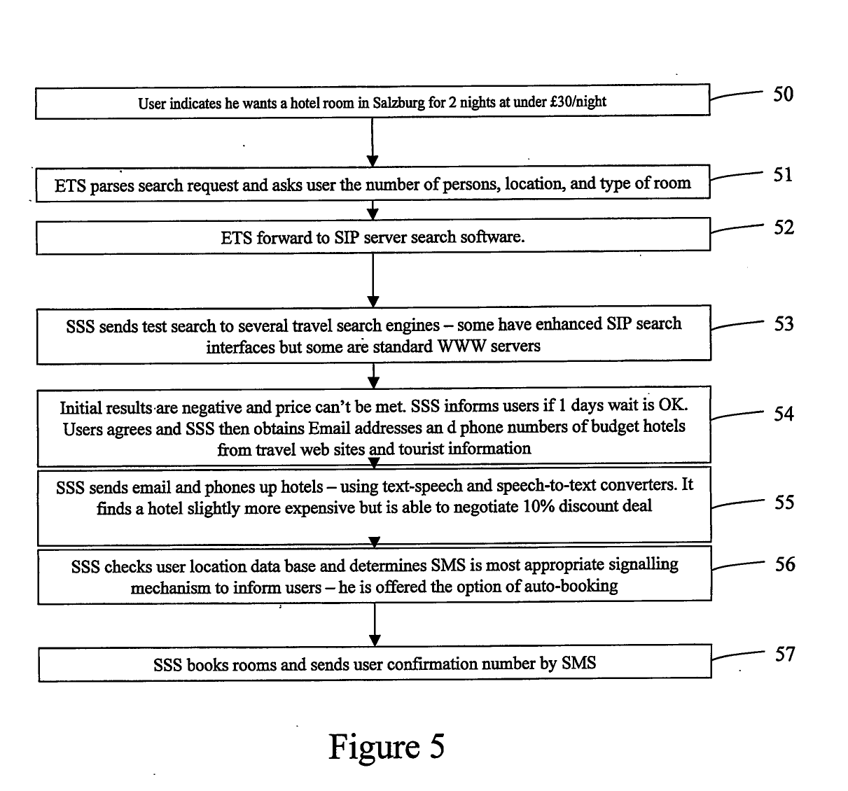

FIG. 5 shows schematically an embodiment of automatically completing a transaction to secure an item returned by the search result according to another embodiment the invention;

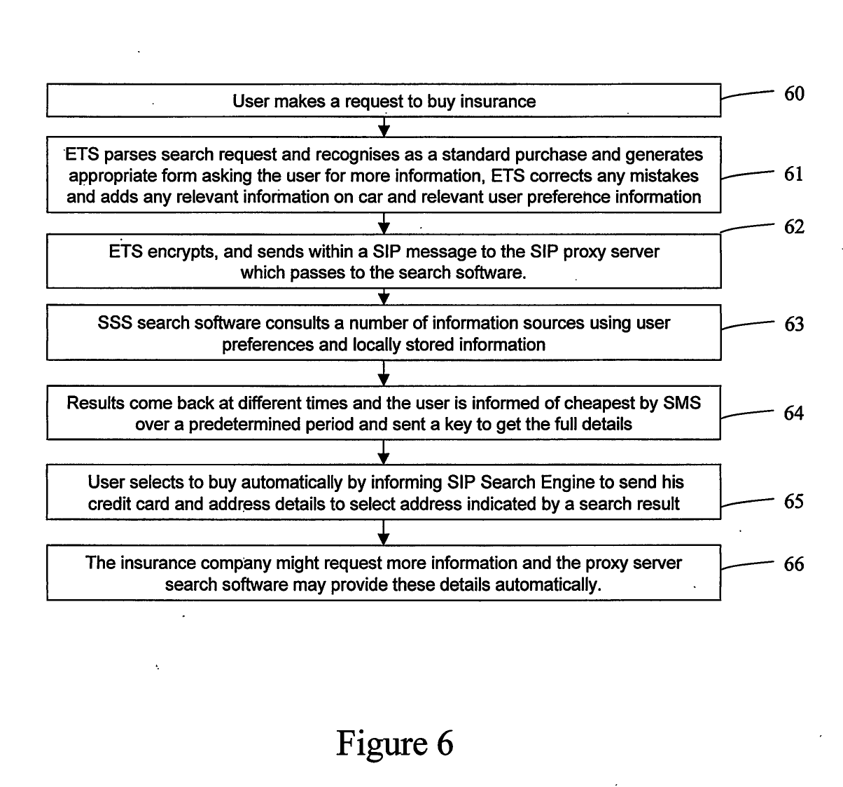

FIG. 6 which shows schematically steps in another embodiment of the invention in which a user is prompted for more information to improve the search process and enable the search results to indicate a price for the item to be purchased;

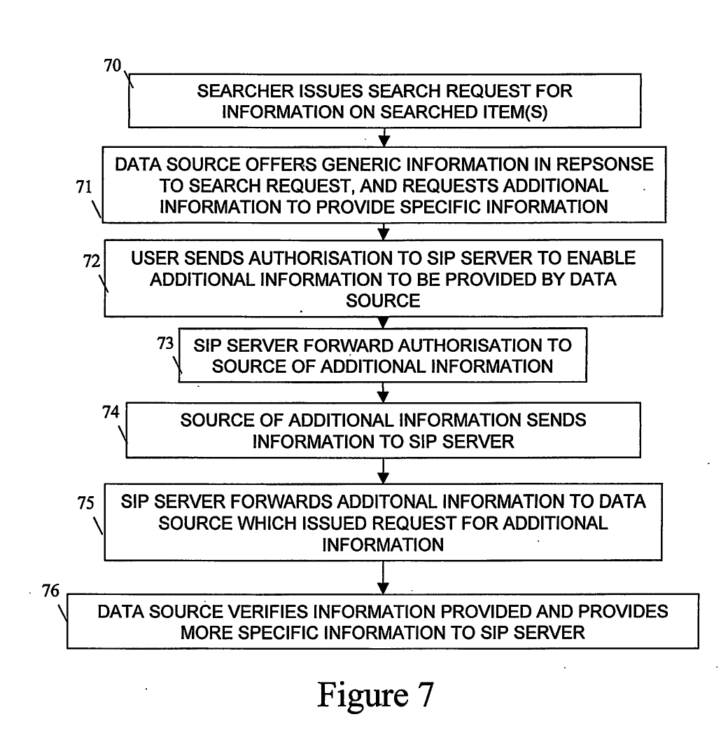

FIG. 7 shows steps in a search method according to one embodiment of the invention in which a data source contacted during the search requests additional information from the searcher;

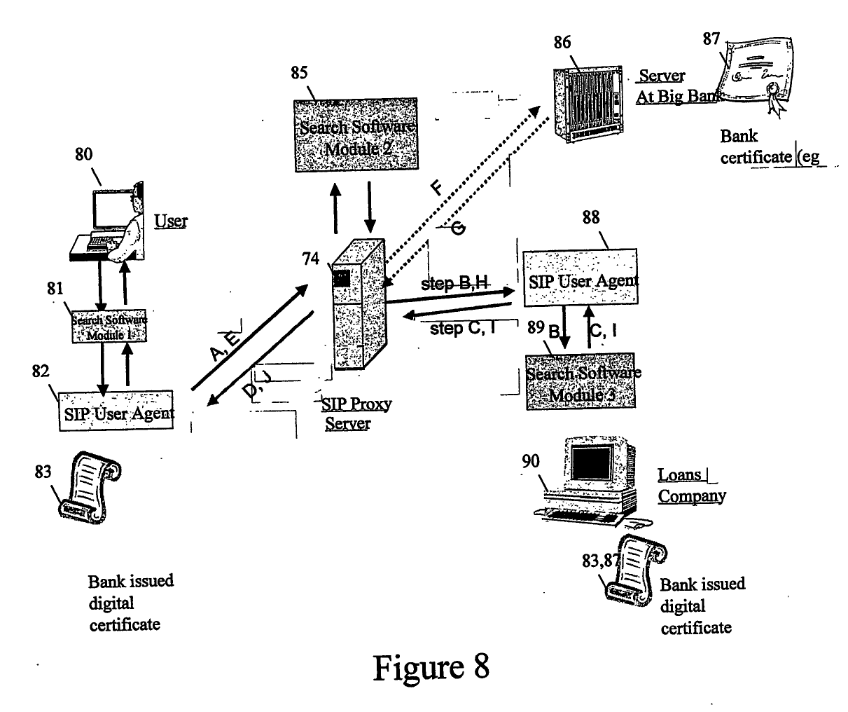

FIG. 8 shows schematically a scenario in which a search method according to the embodiment of the invention shown in FIG. 7 may be implemented; and

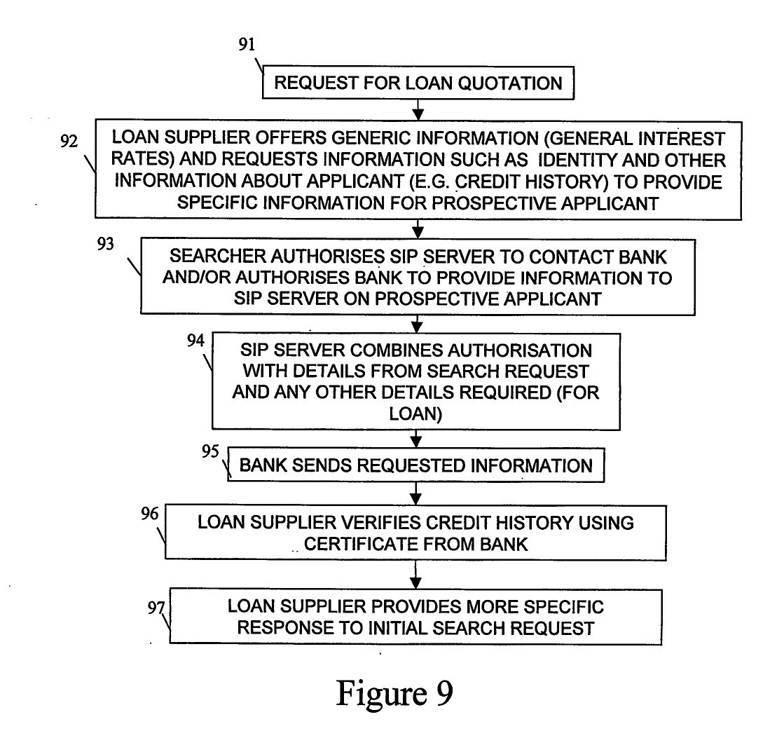

FIG. 9 shows schematically steps in the search method embodiment of the invention shown in FIG. 8.

The best mode of the invention as currently contemplated by the inventor will now be described by means of specific embodiments of the invention. The best mode of the invention as currently contemplated by the inventors is supported by the session initiation protocol (SIP). SIP is the Internet Engineering Task Force's IETF's standard for multimedia conferencing over IP. SIP is an ASCII-based application-layer control protocol and is defined in RFC 2543, a copy of which is filed herewith and the contents of which are incorporated by reference.

SIP can be used to establish, maintain and terminate calls/sessions between two or more end-points. More specifically, SIP provides session management within a packet telephony network which provides the ability to control the attributes of an end to end call as well as signalling which enables call information to be carried across network boundaries. Thus SIP provides the ability to: locate the endpoints via address resolution, name mapping and call redirection; determine the media capability of an end point; determine the availability of an end point; establish a session; handle the transfer and termination of a call; and have an identity associated with one or more address mappings, as is well known in the art and defined by RFC 2543.

Those skilled in the art will recognise that although the invention is described in the context of the SIP protocol as described in RFC 2543, the invention is not limited to the SIP protocol per se but extends to any protocols derived from the SIP protocol which support the SIP functionality used by the invention. For example, the invention can be implemented by any protocol which enables a proxy server to: locate the endpoints via address resolution, name mapping and call redirection; determine the media capability of an end point; determine the availability of an end point; establish a session; handle the transfer and termination of a call; and map an identity to a number of static and/or dynamic addresses, providing the protocol also enables a search session to be given a unique search identity by proxy server search software, and providing the search is been initiated by a user registered with the proxy server and assigned unique user identity having the above properties, and providing the proxy server is able to associate the user identity with one or more user preferences. These features of the protocol are necessary to enable the proxy server to modify and/or filter the search query as appropriate and to select a user end terminal to forward the results to in an appropriate format.

Referring now to FIG. 1 of the accompanying drawings, a distributed computer system over which data can be retrieved using a search method according to the invention is shown. In FIG. 1, a SIP-supported data searching system for retrieving data using a distributed computer system according to an embodiment of the invention is shown. The SIP-supported data retrieval system comprises a plurality of devices supported by appropriate software modules enabling the devices to interface with each other over the distributed computer system.

The distributed computer system shown in FIG. 1 comprises a communications network which includes at least one user operable end terminal 10, a SIP proxy server 12 and at least one data source 14. The end terminal 10 may comprise any type of device capable of relaying information to the SIP proxy server 12 in the form of a search request. As shown in FIG. 1, for example, a personal computer 10a or a mobile phone type device 10b capable of connecting over the communications network to the SIP proxy server 12, which may its self comprise a plurality of components, for example, a central server 12a and a data storage facility 12b, which may for example provide a database of user preferences and/or past search results, or search results which have yet to be communicated to and/or retrieved by a user who has submitted a search request. In certain embodiments of the invention, the SIP proxy server 14 may itself comprise a distributed computer system, for example, the proxy server may retrieve the user preferences from a separate data base storage system via a communications network.

Those skilled in the art will realise that a variety of forms of connection (wireline, wireless, dial-up, broadband ASDL etc, LAN etc connections) are possible and that the end terminal 10 could be a portable device. As the connection need not be permanent an end terminal 10 which sends a search request to the SIP server 12 does not need to remain connected to the SIP server 12 after the search has been sent to the SIP server 12. The invention enables an appropriate end terminal 10 to be located for forwarding a search result to, according to one or more user preferences established by the user and/or by the end terminal software and/or proxy server software. A user end terminal 10, the SIP proxy server 12 and a data source 14 interface with each other either directly or indirectly as appropriate according to specific embodiments of the invention, for example, search results returned by a data source 14 may be sent (if a user preference/search request permits it) directly to an end terminal 10 in one embodiment of the invention.

Referring now more specifically to FIG. 1, two end terminals 10a, 10b shown by way of example comprise a personal computer-type 10a and a mobile telephone type device 10b. End terminals 10a, 10b are each capable of being connected independently to other elements in the computer system, i.e., to a the SIP proxy server 12 and to at least one data source 14. It will be appreciated by those skilled in the art that the data source 14 from which or via which information is retrieved does not need to be limited to the specific examples 14a, 14b, 14c shown in FIG. 1. In FIG. 1, data source 14a comprises a web server, data source 14b comprises a search engine (or database), and data source 14c comprises a phone terminal.

A plurality of software modules #1, #2 and optionally #3 are provided, components of which may be localised on an individual device or may be distributed across one or more devices. Software module #1 comprises end terminal software (ETS) which runs on the user end terminal 10a and interfaces via SIP user agents with software module # 2 which comprises SIP server software (SSS) run by the SIP proxy server 12.

Software module # 3 is provided optionally at the data source 14. The data source 14 may comprise, for example, a conventional search server or even a phone type device such as 14c in FIG. 1, which may not be provided with software module # 3. For example, consider where the proxy server 14 is querying a conventional search engine such as Google™, and where no new software is provided (i.e., if software module #3 is not present on the device queried), for example, the web server 14a in FIG. 1.

Although Google™ can be queried in a conventional way, Google may later provide an API (Application Program Interface) which could enable more complex, enhanced or more efficient SIP searches to take place. Alternatively, the proxy server 14 could have processes a returned search result to determine that a specific web-site should be resent the search request formatted in a specific way, for example a travel web-site for checking or booking flights. Such a web-site may operate in a SIP-enabled or non-SIP enabled manner. As an example, in FIG. 3, software module # 3 comprises search database/engine software SDB which runs on the search server (equivalently known as the search engine) 14b.

The term end terminal 10 as used herein refers to any device suitable for generating a search request and/or receiving a search result. The user end terminal 10 can comprise a personal computer type device 10a as shown in FIG. 1, however, those skilled in the art will appreciate that the user end terminal 10 may comprise any device capable of remotely accessing the search engine and/or displaying search results, for example, a personal digital assistant type device such as the PalmPilot™, or a mobile telephone type device 10b such as is shown in FIG. 1, which a user can operate. The end terminal 10 to which the search result is sent may not be the same end terminal 10 which generated the request.

In one embodiment of the invention, the end terminal 10 which receives the search result is not capable of generating a search request, but is capable of displaying a search result (for example, the user end terminal 10b may comprise a mobile phone type device which does not have sufficient memory capacity to support the generation of a search request, but which can receive a search result in the form of an small message service (SMS) text message).

A user of an end terminal 10 is assumed to have set up a SIP identity URI, in the manner described in RFC 2543 for example, and requests a search by entering an appropriate search query into an appropriate search application. The search application can provide any appropriate interface for the user to enter search terms, and it will be appreciated by those skilled in the art, that whilst a computer type terminal such as is shown in FIG. 1 would support a sophisticated Graphical User Interface, if a search were to be requested by a less sophisticated device, the user interface can be much simpler.

FIG. 2 shows steps in a method of searching for data to be retrieved from a distributed computer system according to the invention.

In FIG. 2, in step 20, a user initiates a SIP search session at an end terminal 10 and generates a search request which will include information on the user's SIP identity. The user's SIP identity could be entered either manually by the user as part of the search request but in the best mode of the invention is generated automatically as a result of the user initiating the SIP search session.

The search request comprises at least one search criterion and is generated using an appropriate search software application adapted to interface with the ETS (end terminal search software module #1). When the search is requested by the user, the search software application passes the search request to the ETS. The ETS software module then modifies the search request according to at least one user preference in step 21.

A user preference used to modify the search result at the end terminal 10 may have been determined in a variety of ways. For example, the user preference may have been either predetermined by the user who has entered a personal profile comprising a set of one or more user preferences (for example, no interest in football or strong interest in Bath as a town/place but not as a bathroom item). The ETS software module will have associated such a user preference set with the user's SIP identity. The user preferences may be supplemented or replaced by one or more user preferences which the ETS software module has determined automatically from analysis of the user's historical search activities, i.e., by analysing which search results indicating a web-site resulted in the user visiting the web-site.

The ETS then encapsulates the search request within a SIP message in step 22 of FIG. 2 using a search description protocol (SEDP) according to the invention, and sends this to the proxy server.

The proxy server then passes the encapsulated search message to the proxy server software module SSS in step 23 of FIG. 2, and the SSS then de-encapsulates the search request to process the request further according to the user preferences in step 24. The further processing of the search request may be based on additional user preferences which the proxy server has determined, for example, that results from a particular data source have historically resulted in the user being more likely to access the web-sites indicated in the search result, and the proxy server may then generate a user preference for that data source to be accessed again.

Alternatively, the proxy server may have a central scheme for discounting any price which is returned in a search result from particular types of web-sites according to a scheme which the user has subscribed to. The amount of discount may be fixed or vary according to certain conditions. The fact that discounts should be obtained and/or the details of organisations which the user is a member of could be provided as user preferences which are used to modify the search request.

The user preferences which the proxy server has noted may also vary and not be fixed, for example, according to the time the search is generated and according to the priority of the search. For example, the proxy server may note the search is urgent and so will always notify the user immediately a result is received, even if the user preferences forwarded by the ETS indicate a user preference for not notifying immediately). Thus one or more proxy server user preferences may in some embodiments of the invention, override one or more end terminal user preferences.

The proxy server then processes the search result and forwards it to a data source in the appropriate format in step 25, for example, either as an email or a normal search request to a non-SIP enabled search server such as 12a shown in FIG. 1, or even convert the search request to a suitable query and connect to a telephone data source 14c such as FIG. 1 shows.

The data source 14 then processes the search request to generate a search result which is conveyed as a search result message to the proxy server 12 in step 26. Depending on the type of data source, the search result may comprise a audio file, for example, if the data source is 14c, the person answering the query may have their answer recorded as a voice-memo and stored in an audio format. The answer may however, be converted at some suitable point using speech to text technology to a text file, and the search result would then have a more conventional format.

The user may have set up a preference to convey an indication with the search request that search results should be sent directly to the user's end terminal in some embodiments of the invention. For example, if the request is very urgent or if the user has a preference set up that results returned in email format should be forwarded directly to the user's mail server and not returned for further processing by the proxy server. This direct return of the search results option is not indicated in FIG. 2, as in general the search results will be processed by the SIP server to determine an appropriate location for the results to be stored and/or sent to an end terminal.

The proxy server 12 de-encapsulates the search message it containing the search result then processes the search results received, and generates a search result having a format compliant with the user preferences and/or with the end terminal to which the proxy server has determined the results should be sent to in step 27.

Unlike a conventional search request, which may simply return a website where a user must then re-enter additional information if the user generates a search request for “cheap flights to Egypt”, the SIP proxy server 12 is able to process the search result to enable further interrogation of a data source to determine more relevant search details. This further interrogation may be enabled either by the initial processing performed in step 24 of FIG. 2, or as part of an iteration of the search process steps 24 to 26 performed within the processing performed in step 27 in FIG. 2, prior to delivering this to the user end terminal.

As an example, if data source 14a returned a URL for a web-site for a travel company that has an on-line booking system, the SIP proxy server may already be aware of the format the on-line booking system would require to find out specific details of flights and would then provide information to enable the booking system form to be effectively filled in. Alternatively, the SIP server may interrogate the booking system to determine the information required. Once the SIP server has obtained a specific result which conforms with the user's search request to the level required (i.e., specific flight information has been obtained), the SIP server forwards this information as a search result to the user. If the SIP server is aware that the user has frequent flyer miles or is a participant in another discount scheme (either as an individual, or if some organisation the user is a member (and which is recorded in his user preferences) has a discount scheme), this information might also be submitted by the SIP server, so that the user is also given information on the price of a flight which takes his frequent flyer miles into account. In this way, the search results returned by the SIP server are much more relevant to the user. In a similar manner, car insurance sites, theatre ticket sites, etc., and all be further interrogated to get specific information relevant to the user's initial search enquiry.

The method of encapsulating the search within a SIP message is performed using any suitable search description protocol (SEDP) which can be devised to provide a structure to the search request generated by the user at the end terminal 10. For example, in one embodiment of the invention, the SEDP provides a structured search request format which includes fields to indicate a set of search characteristics. The search characteristics provided indicate the type of search and a range of at least one search criterion, and may optionally include one or more user preferences. The one or more user preferences can be generated by the end terminal SIP software module #1 or by the proxy server software.

FIG. 4 shows an example of a SEDP, and is described in more detail later on, but in general a an search description protocol according to the invention will support one or more of the following characteristics:

Security (encryption);

User SIP id;

a variety of search descriptions fields (eg XML/free text/keyword selection);

information on current session context (what user has been doing eg Email, how long connected, how long on current IP address, . . . . ); and

information on cached recent searches on terminal (eg large files might be held on the terminal and should not be sent again).

Those skilled in the art will appreciate that FIG. 4 shows only some features of a search description protocol SEDP according to the invention and another protocol which is able to encapsulate the search request within the SIP message could be implemented instead. The essential feature is that any search description protocol needs convey at least the search request information and the user's SIP identity universal resource indicator (URI). In one embodiment of the invention, the ETS may be configured to format the search string the user has entered so that this conforms with a more efficient search expression. In another embodiment of the invention, the ETS may cache one or more previous searches. This enables the ETS to add updated information to a cached search to facilitate the search request process.

Returning to FIG. 1, a user terminal generates a search request which is encapsulated by the end terminal SIP software. The encapsulated SIP message is then transmitted from the user end terminal to a SIP proxy server 12 with which the user has registered the user end terminal as a SIP terminal 10. The SIP proxy server 12 may have several registered user end terminals which the SIP proxy server is able to determine are associated with a particular user SIP identity.

When the SIP proxy server 12 receives the encapsulated SIP message, the server forwards the encapsulated message to the SIP proxy server software module #2 SSS. The SSS software module then processes the received message to de-encapsulate it. The SSS software module then analyses the search request in accordance with a predetermined set of search rules which are configured by the SSS and which may be determined at least in part by at least one user preference which the SSS is able to associate with the user's SIP identity URI.

In one embodiment, the SSS software module may further modify the search expression and/or select specific servers within the distributed computer system to forward the search expression to according to the user preferences associated with the user's SIP identity URI.

The search is modified in accordance with any specific user preferences. The user preferences which are used to modify the search may be a subset of the total user preferences which are available, and the SIP proxy server 12 may select the user preferences to be used to modify the search by analysing the search request and determining which user preferences are appropriate to the search. For example, the SIP proxy server 12 may select a user preference to indicate search results should be sent to home if they relate to a leisure activity and to work if they relate say to financial items, so that the user preference for which end terminal results should be sent to is selected according to the type of content which the user has requested. By incorporating user preferences, the SIP proxy server software can perform certain additional steps to ensure any personal preference information associated with the user's SIP identity is incorporated into the search request as a supplementary search expression, or use the users personal details to perform a supplementary search to obtain more relevant results, or even purchase an item located by a search.

For example, the SIP proxy server 12a may access database 12b to retrieve a set of at least one user preferences which are associated the user's SIP identity, such as the user's hobbies, the user's search preferences, the user's past search results, the user's past user actions after search results, and the user's most frequently accessed web pages. These user preferences are then used to reconfigure the search request. The user preference information could be used by the SIP server to add supplementary search expressions which include negative search criteria. For example, a user preference to indicate that unless expressly entered as a key word, no results should refer to a specific keyword should be included. In this way, a user can set a user preference for a keyword such as “Football” to not feature in any search results. The SIP server then can modify received search requests to automatically include in the search expression information equivalent to the boolean expression “AND NOT football”. The modified search expression then results in search results being returned to the user which exclude football-related information. This is advantageous as if the user's preferences indicate the user wishes to exclude search results for football related sites when a search is being performed over a communications information network such as the World Wide Web on the Internet, a search for “Manchester” for example, would not result in search results being forwarded to the user which referred to “Manchester city” or “Manchester United” or any other football related site which mentioned “Manchester”.

The user's preferences may include search site preferences which would indicate one or more search sites are to be included (and/or excluded search sites) in the search, a maximum search time for the search to be active, and, search result terminal and/or result formatting information.

The SIP server 12 then selects a number of search engine/server/sits in further SIP messages. The further SIP messages may be encapsulated or may not be according to whichever form is most suitable for the specific server being queried. For example, some messages could use a new protocol if a server was equipped with an appropriate search interface—API) between the SSS and SDB. The protocol would need to have one or more (ideally all of the following features):

be secure (e.g. the protocol might use Ipsec);

provide authentication—for example, the protocol might require authentication of servers (to check for Fakes);

support compression (of the query and/or of the result); and

allow caching on the SIP proxy ideally (at a very high level, for example, if a highly popular football team scored a goal and the number of users who may search for a video clip of this to download could reach as high as 10 million, however, the SIP server would only need to retrieve this video clip once!).

More than one protocol could be utilised to transport the SIP messages, for example, if a SIP Proxy server needs to provide queries in a number of ways, for example, the server could send a normal email to a mailing list requesting more information on the search expression (or an expression derived from the search expression), or even (using a suitable automatic voice generation application) phone a hotel, or fill out a Web form (all of which forms of further querying use different transport protocols).

As an example, in a typical query message according to the invention, the following information could be provided:

Origin IP address: 123.32.123.001

Origin URI: name.surnameofuser@atelco.com

Hash: 4387t84gf8t4f84tg83rtf8p32yh239f8y[98fy9[8747643865gffgyfrjylegfgv,uegyvjgvy

Search reference: 653467252

Search terminal type=Pentium III PC

Account type: Individual

Average Internet access activity duration: 2 hours

Previous Activity: email

Location of terminal: Ipswich, England

Request type: TRAVEL

Request: Date 23/1/04;

From: Stansted;

To Moscow;

Time: unspec;

Cost CHEAPEST;

Return No

End ReqType

Return: Instant(123.32.123.001), update (day, Mobile—name.surnameofuser@atelco.com)

Cost—Bill 1

END

Each search is assigned a unique search number by the SIP proxy server 12 so that the SIP server 12 is able to match any replies to the original search request even if the user is not longer in communication with the SIP proxy server 12 via the user end terminal 10.

When the SIP message carrying the search request is received by a data source 14, typically an information source such as a search server 14b, the message contents are extracted and are processed by the appropriate SIP software module located on the other server, e.g. the search engine SDB software module #3 located on the search engine of a search server. Alternatively, if the SIP server chooses another transport protocol, the message contents may be processed in the normal way (eg Web form) for the site queried, for example, as would happen if a conventional search engine (i.e., non SIP enabled) were queried by the SIP proxy server 14. Also, if a SIP server 14 forwards the search request to a data source such as a mailing list or email address for a particular body or organisation of interest regarding the search request (whose addresses may have been located by earlier search requests by the user or provided by a preliminary search result generated by a conventional or SIP search engine), the data source will not be SIP enabled.

When a search request message is received by a data source 14, if the data source 14 determines one or more results to the search criterion/criteria set by the user's search request, the data source will forward the search results in an appropriate manner to the SIP proxy server. Where a SIP server 14 has actually telephoned a number and announced the search using text-to-speech technology, the person who responds to the search may be given a number to contact and a password so that they can respond later to the query. When the person dials the number, they may be presented with the option of entering the code, and then be allowed to record a message. The message can then be associated with the SIP identity of the user and the search identity using the code entered. This then enables the message to be forwarded to the SIP server which might convert the audio file to a text file using speech-to-text technology, or forward the file to the user as a search result for the user to play on their machine. A similar process is undertaken where the SIP search message is forwarded to an email or mailing list address so that any response can be identified by the SIP proxy server with the user's SIP URI (or key to get information at a later point in time (see the description above).

When a SIP enabled search engine 14b encapsulates one or more results in a SIP message together with the unique search number and forwards this to the SIP server, this enables the SIP proxy server 12 to associate the search result with the SIP identity of the user who requested the search.

When the SIP proxy server 12 receives a SIP message it extracts the search result and search number. The SIP proxy server 12 associates the search result with the SIP identity of the user who requested the search. The SIP proxy server search software module # 2 SSS may store results for a specific search number according to the set of user preferences for a predetermined period of time or until a specific number of positive search results are received. Null search results can be forwarded by the SIP proxy server to the user and/or near matches provided in accordance with the user's preferences.

The SSS software module then determines the user's current location (as located in the SIP location database), the user's terminal type at that location and format (determined in accordance with the user preferences). For example, if the user does not wish to receive the search results until a certain time, or does not wish to be disturbed, if this information is recorded on the SIP database of SIP user preferences, then the SIP proxy server is able to process the search results appropriately and format the results for the appropriate terminal display.

The user may also specify more than one location for results to be sent to, for example, a short descriptive form (for example, just a town if the user has search for a company's location) may be sent to the user's mobile phone, which could alert the user to log into their personal computer (to which the SIP proxy server software would have sent a SIP message which encapsulated the full address of the firm as a search result).

As SIP associates currently valid addresses with a SIP user ID, and uses these to deliver the search results there is not need for a user to retain an open search session with the search engine whilst the search is being performed. The search can use permanent SIP addresses which enables results to be collated and a user is therefore also able to specify if, for example, they wanted results to be returned collected into 10 “hits” until the search time has expired, after which any remaining searches should be sent to the user.

As the user is able to designate the terminal and format the search results are to be provided by, it will be appreciated by those skilled in the art that the search results could be provided in form which is accessible when the user next runs the search software module #1 search application, or alternatively be sent in the form of an electronic mail message (e-mail message) or short message service (SMS) message.

As the protocol user identity associated with the user, for example, the SIP URI name.surnameoftheuser@atelco.com, is permanent, this can be associated with a number of addresses/phone numbers which may be static or dynamic, for example, with telephone number such as 01234 123 456 or an address such as 111.223.123.011 . . . )

Another aspect of the invention relates to a distributed search environment in which the SIP proxy server search software module #2 determines the capabilities/specialities of one or more search engines/servers within the distributed computer system. For example, this could be achieved by sending a request for information to the search engines/server, but other mechanisms which can be used include web crawling (for example, such as Google™ implements) or by being sent advertisements, or any other way in which it is possible for the proxy server to discover their capabilities/specialities. The search software running on these machines uses another protocol (Search Capability Protocol CCP) to describe their capabilities (for example, speed, data bases searched, the type of files searched (e.g. *.doc, or *.pdf file names), etc. to the SIP proxy server 14. The SIP proxy server 14 is then able to determine which search engine is most suitable for a user and/or a specific search requested by the user, for example, by considering the search request, user preferences.

### EXAMPLE 1

A specific embodiment of the invention will now be described by way of example with reference to FIGS. 1 and 2 of the accompanying drawings.

Consider a user who wishes to locate information on trams. The user has a history of accessing many tram and transport related web-sites on the Internet, has transactions which record the purchase of model trams, and is listed on at least one transport enthusiast email list.

The SIP proxy server has recorded this information in association with the user's SIP identity and the user is assumed to have set their preferences to indicate that they are interested in transport. Accordingly, both the ETS software module and the SSS software module will record this information as if the user has used SIP for all of their sessions, including browsing, email and Instant messaging, all the information built up about the user's information sources and preferences will be accumulated in association with the user's SIP URI identifier—for example users.name@businessname.sip.

Repeated use by the user of the information retrieval search system according to the invention will result in the user having activated (for example by clicking on a highlighted URL returned with the search results) features which fall into the set (site type=museum, request=information, . . . etc) and this information will be stored on the SSS.

Other data mining of the user's previous sessions can also be used to optimise the search to suit the user's preferences.

Consider the user has the specific request of wishing to restore an old tramcar and so the user enters the search phrase “tram, restoration, projects, buy” in step 20 of FIG. 2. The user may naturally supplement these search terms with appropriate Boolean operators and wild card characters etc, however, a simple key word such is given here as an example with the implicit assumption the key words are separated by commas and link by an inherent “AND” so that all the key words must be present before the search results are returned.

The ETS software then parses the search request to indicate additional information which is accessible to the ETS software in step 21 of FIG. 2, for example:

Search terminal type=Pentium III PC

Account type: Individual

Average internet access activity duration: 2 hours

Previous Activity: email

Location of terminal: Ipswich, England

This request is then packaged, using the Search Description Protocol, in a standard SIP message in the manner described in RFC 2543 and transmitted along a communications link to the SIP proxy server 12 in step 23 of FIG. 2.

The SIP proxy server 12 then passes the (unopened, i.e., still encapsulated) message to the SSS in step 24 of FIG. 2. The SSS is an “intelligent module” capable of making requests to a large number of databases and specific sites or search engines (some but not all of which may have SDB software modules). As an example, the SSS can send the request to one or more of a plurality of different information forums, for example:
i) the SSS can send a request to a news group on trams in the form of a request for information which the SIP server automatically generates;
ii) the SSS can send the request to a transport web-site that logs potential projects and restorers (and tries to match the two) which has SDB software which enables the two software modules to create a user entry (as the user might need screening from replies this might be to an email account: 876462965@atelco.com which is created just for this search entry alone, and which would therefore screen the user from spam email which might otherwise be generated if the user's normal email address was given);
iii) the SSS can send the request to a standard search engine such as Google™ (www.google.com or www.google.co.uk) from which the SSS is able to request a specific number of results, for example, 1000 responses. The SSS then filters the responses provided by the conventional search engine to ensure that the search results conform with the user preferences the SSS is aware of for the SIP user identity which requested the search. The SSS can further interrogate the user if the SSS detects that ambiguous results are being generated (for example, by using a built in statistic/pattern matching program the user could be asked “Do you mean you want to BUY a TRAM?”). The SSS can then incorporate the user's response to such a further query to refine the search terms the SSS uses to interrogate standard search engines;
iv) the SSS can send the request via email to one or more other individuals or mailing lists who/which the SSS is able to determine have associated with trams as a subject matter of interest; and
v) the SSS can send a request via email to a museum such as the national transport museum.

### EXAMPLE 2

FIG. 3 shows in more detail steps in the process of generating search request at the user's end terminal. In FIG. 3, in step 30 a user initiates a search session at the user terminal, for example, using either text or speech (and a suitable application to generate text from the spoken search request). The ETS parses the search request to identity a possible pro-forma it is aware of for that type of enquiry in step 31, for example, if the search has a travel or financial aspect. This enables direct interrogation of web-sites such as travel sites, and may remove additional processing of search requests/results by the proxy server such as were described in the context of step 27 in FIG. 2. If additional information is needed, the ETS may request this of the user and if the ETS detects a mistake, then it may query this with the user. In the context of a travel enquiry, the ETS may provide the user with a generic form which requests departure dates, cost preference etc, and if the departure date is before the arrival date detect this as a mistake.

The ETS checks to see if previous searches have been performed in step 33. For example, the user may have requested the same information a few days earlier, in which case the generic form may be presented to the user with appropriate information already completed, or the ETS may alternatively have cached some search results. If a similar search has been recently performed and is held in cache on either the end terminal or on a server such as the proxy server 12, then only an update needs to be sent to the user.

The ETS then formats the search request in step 34, for example, the travel search request may have a pre-set “destination, time, departure point, time” field format.

The ETS then encrypts the search request with a session key in step 35, which was established when the user authenticates at the start of the association of the address of the end terminal and the SID id.

The ETS then places the encrypted payload in a SIP message with TYPE set at SEDP (the search description protocol) in step 36.

The ETS then sends the SIP message to the proxy server in step 37.

FIG. 4 provides an example showing the format of a SIP header and SEDP search description according to an embodiment of the invention.

The SIP header includes at least the following information:
i) INVITE sip:search@bt.co.uk SIP/2.0—this indicates the SIP header relates to the invitation from the SIP server to a search engine
ii) VIA: SIP/2.0/UDP spainitel:5060;
iii) From: Joe Bloggs<sip:joe@atelco.net>—this is the SIP URI of the user;
iv) To: Search <sip: search@uk.net>—this provides the SIP URI of the search service;
v) Call-ID: 10000001@sipsteme.net—this is the call of the SIP session, which can terminate early before the search result is returned;
vi) Cseq: 1 INVITE—this is the sequence number of the SIP call;
vii) Subject: Urgent Search—this could be a plain text entry or provided as a field which an end point uses;
viii) Contact: Joe Bloggs<sip: joe@atelco.net>

Additional fields which the invention provides in the SIP header indicate the SIP payload, and include:
ix) Content-Type: application/SEDP—the type could be used to send an IP address, but in general is used to indicate that instead of a MIME type application, the application is a session description protocol according to the invention, SEDP (SEarch Description Protocol);
x) Content-Length: 160—this indicates the size of the payload, the number 160 is given by way of example only.

FIG. 4 also indicates a SEDP according to an embodiment of the invention where a travel enquiry forms the body of the search expression. As shown in FIG. 4, the SEDP comprises the following:
i) Type: travel.air—the type field indicates a specific search field where appropriate;
ii) F=Luton; 13,4,04; d=Ulan Botar; 28,4,04;;;—these fields indicate the point of departure is Luton, the departure date is 13 Apr. 2004, the destination is Ulan Botar and the return data is 28 Apr. 2004, followed by a number of null fields.
iii) AP=British A, NOT Aeroflot, other—these are user preferences which indicate positive preferences (British Airways) and a dislike (Aeroflot)
iv) P=Price—this field is being used to indicate that price is a priority feature of the search
v) U=instant; update (phone 1)—this field is being used to indicate that the search results should be communicated to the user end terminal indicated by phone 1 instantly when they arrive.
vi) T=urgent—this gives the priority of the search;
vii) OS=Hotel, Car Hire, Insurance—these are other services which are relevant given the category of the search, so the proxy server may wish to report information on these services if they are returned by a data source;
ix) Sid=7684^{ΛΛ*}jjkkj84—this is the ETS session identifier which resides above the SIP id, and which may or may not be associated with SIP.

Fields ix) and x) in the SIP header (and so also all the fields in the SEDP search description in the payload) may be encrypted in some embodiments of the invention, as indicated in the steps outlined in FIG. 3 of the accompanying drawings.

### EXAMPLE 3

FIG. 5 shows an very specific embodiment of the invention in which a user indicates they want a hotel room in a specific location (for example Salzburg) for a specific duration (for example 2 nights) at a specific cost (under £30 a night) in a search request in step 50.

In step 51, the ETS passes the search request and asks for more information, for example, the number of people, the exact location, and type of room, and a start date.

In step 52, the ETS forwards the message to the SIP proxy server whose SIP search server software SSS then processes the message (having de-encapsulated it).

In Step 53, the SSS sends an initial search to several travel search sites, some of which have enhanced SIP search interfaces but some of which may be standard world-wide web WWW servers.

In Step 54, the results returned are negative as the price cannot be met. The proxy server then may ask the user for more information or to revise the search and/or ask if the duration of the search could be extended so that search results could be returned at a later point, for example, 1 day later. In FIG. 5, the user sends a response to the SIP server that it is possible to perform an extended search and for results to be provided 1 day later. The SSS then searches for hotels which do not have on-line booking facilities to determine email addresses and/or telephone numbers on travel web-sites and tourist information sites.

In Step 55, the SSS sends out email enquires in a format generated from the search request, and phones up hotels using text-speech and speech-to-text converters. The SSS obtains a near result and noting that the user is a member of at least one potentially relevant organisation, provides this additional information to the hotel providing the near result to obtain a discount, for example 10%.

In step 56, the SSS checks the user's location database and determines that an SMS would be most appropriate (for example, the SSS may recognise that the time is outside the usual range of hours a user operates their computer at home or work). The SMS informs the user that a room has been found which meets all of the search requirements and asks the user if the booking should be automatically completed. This option is possible as the user has already registered bank account/credit card details to enable automatic purchasing and may have set a user preference to indicate that automatic purchasing should be enabled. In other embodiments, the user may set a user preference to indicate that if all criteria are met, the purchase should proceed automatically without a prompt.

In step 57 of FIG. 5, the SSS books the room by providing the financial information to the hotel either by email or by fax and informs the user that this has been done. In FIG. 5, the SSS waits until a confirmation number has been received from the hotel and then forwards this by SMS to the user. Alternatively, the SSS could notify the user as soon as the financial details have been sent to the hotel, or have been indicated as having been received by the hotel (for example, in the case of an email being sent when a receipt for reading is received or in the case of a fax, when the fax is confirmed as successful).

As has been mentioned above with reference to specific embodiments of the invention, it is a feature of the invention that both the end terminal software ETS and the SIP proxy server software SSS is arranged to modify a specific search expression (i.e., the phrase entered by the user on the end terminal) so that any requests for information which generated by the SIP automatically have an appropriate format for the destination to which the search request message is to be forwarded to.

The responses from these searches can be generated over several different timescales, ranging from virtually instantaneous for the conventional search engine results to several days, weeks, months or even years for the emailed requests for information. A user is able to indicate either in the search expression or as a user preference (which may be derived from the search expression), the maximum duration a search may be conducted for. This could be implemented by indicating to the proxy server 14 a cut-off time after which search results returned should be discarded. Search results which are returned to the proxy server 14 after the initial search session has terminated can be processed as the SSS is able to associate the results with the original request using the unique search identifier associated with each search (which can be given in a form such as 1234567@aserver.telco.umts)which is issued by the SSS. The SSS is then able to process response and may iterate the search procedure to obtain additional information as the search results arrive by processing the results before the results are notified to the user.

The form of the results and the mechanism by which the user receives the results can all be set by user preferences. Typically, the user might indicate that results should be provided in one or more of the following forms:

i) as a weekly summary of responses;

ii) as an instant reply (within 1 minute);

iii) only best match answers should be sent via email as high priority.

The user might always indicate that the search should be cancelled at any time, and this too can be easily accomplished as the SIP search number uniquely identifies the search. The user may also

The SSS can use the facilities of the SIP proxy server and its associated location database to locate the user at any given time (since the user's IP address is not a reliable location after several minutes or hours). The location database returns the users current terminal type and the SSS is able to adapt the response to suit the user's current terminal. As an example, consider if a tram enthusiast responds to a news group item that he has a 1933 GEC/Norwich tram in his back garden in Felixstowe. The SSS is able to determine that the sender of the email is at a user end terminal located in Felixstowe, and the SSS is able to determine the distance to Ipswich is sufficiently close (by accessing an appropriate application/database) to rank highly favourably with the user in view of the user having set a user preference that results from locations within a 20 mile radius are to be given high priority. The SSS then locates the user as being mobile and so formats the result in the form of an SMS message to the user on his mobile phone.

The SIP server is able to assess the priority of a result according to its conformance with the user's predefined set of user preferences. If the SIP server considers the result to be urgent (which could occur either because the user designated the search as being urgent or because the user indicated that if the search result indicated a close location, or a cheap price etc) then the SIP server delivers the results to the user immediately (or within a timescale the user has given in his set of user preferences for urgent results to be delivered in) in the format the user has given in the set of user preferences. For example, an urgent search result could be set either to a user at his computer terminal if the user is currently logged on to the network at that terminal with his SIP identity, and/or (depending on the user preferences) the search results could be sent via an SMS or automatically generated vocal message to the user's mobile phone.

The user is able to generate a search query and set the user preferences indicate if results should be given in any format including audio. By providing search results in an audible format, persons who are visually impaired are able to receive search results in a more user friendly manner. It is possible for persons who are visually impaired to set their ETS software user preferences so that it generates a verbal confirmation of the search string they have entered (or to repeat a spoken search request if such a mode of search request generation has been used).

User preferences could be associated by the SIP server SSS software module with the senders SIP URI so that the search results are sent to a destination user end terminal based on the search content (for example,.video files could be sent to the user's work email address if this had a higher bandwidth connection to the internet than the user's home terminal equipment instead of the user's home email address). Alternatively, the SIP SSS software could be configured by the user preferences to automatically compress the search results to a predetermine bandwidth, for example, by sending still clips of a video file to one location and the full video file to another location. Alternatively, the SIP SSS software could simply notify the user that a large file was located by the search and store the large file on the SIP server for a predetermined amount of time until the user downloads the file.

For added security such centrally stored files may only be accessible if the user further enters a security key which the SIP server 12 could send either with the original notification that the file has been located and/or the address where the file could be accessed or via a separate notification. The SIP server does not need to use message type notifications such as vocal messages, email or SMS to notify a user of a search result. Instead, the SIP server may deposit a file containing the search results in the user's public drop file etc.

If the user has requests a search to locate an item for purchase, the SIP server could be provided with the user's financial information such as their credit card numbers etc. and any other information needed to make an automatic purchase of the requested item if the price conforms with the user's set preferences. As an example, consider a SIP server which polled a flight or holiday site for example, and located for example, a return flight to Cairo on the outward and inward dates the user has requested at a specific price. If the price is, for example, either below the user's “immediate purchase” limit or is the cheapest price of a set of search results returned within a given period of time for searching, the SIP server may effect an immediate purchase of the flight so that the price information is correct and the price does not change by the time the user receives the search results. It will be obvious to those skilled in the art that such an automated purchase scheme is not limited to the purchase of airline flights, but could be extended to any item or service offered for sale over a distributed computer system, including items which are under auction but which have an immediate purchase option.

As the proxy server is able to intelligently query certain locations which it believes would be more appropriate for the user's search query, the proxy server can return results which indicate a preferential arrangement with the site providing the search result. This is particularly so if a price is associated with the search query. For example, the search engines which the proxy server access could be configured to always provide a certain predetermined discount (which may be fixed or only temporary in duration). A SIP server search service can then be provided to users whose user preferences indicate they have subscribed to a specific group or body.

For example, if a user indicated they were a member of the Automobile Association and also a civil servant, and the user requested a search for the cheapest insurance for an “S-reg” Volkswagen Punto with ten years no claims bonus, the SIP server could provide this additional member information to the servers of the insurance companies it contacts and the results returned could indicate if an insurance company is able to offer an additional discount to the user based on the organisations indicated in the user preferences.

Alternatively, if may be that the Internet Service Provider (or equivalent body) that the user has subscribed to has discounts with certain third parties such as hotels, software providers, etc., and so the SIP server itself is configured by the Internet Service Provider to offer one or more discounts to the user when it returns a result from the third parties to the user.

The SIP server could keep track of the purchases the user makes with certain bodies and assign one or more points to the user according to the amount and/or number of purchases made, which could be reset within certain timescales. These “points” could then be spent by the user, for example, to get a certain discount off a returned search price or to get an item for free if the search returns a price for that item which could be bought outright with the “points” the user has. In this way, a “reward” scheme similar to the reward schemes currently offered by many chain store retailers can be offered to the user via the SIP search mechanism, whereby each item purchased attracts points and a user is able to purchase further items and/or discounts off other items with the points they accumulate.

Those skilled in the art will appreciate that the spirit and scope of the invention is not limited to the specific embodiments described herein above but instead is defined by the accompanying claims. In particular, the SIP proxy server 14 may itself comprise a distributed computer system, for example, the proxy server may retrieve the user preferences from a separate data base storage system.

An embodiment of the invention involving a SIP search mediated purchase may involve user preferences which are associated with another person apart from the user themselves, for example, a friend or family member. For example, consider where a user wishes to search for an entertainment venue such as, for example, if a birthday party for a young child is to be arranged. A user may enter the key words “child's party venue” and find search results based on their own preferences. However, if for a family member the user may enter “daughter's 7th birthday party”. The ETS recognises the term “party” and provides the user with a set form modified to take into account certain personal preferences which are associated with the user's daughter. In this way, the ETS may bias the results provided to favour those which reflect the user's daughter's known interests, e.g. a children's book character etc.

As an example, the ETS may prompt the use to provide one or more of the following information items in the search expression:
PARTY—(Anniversary, Wedding, Birthday . . . )
LOCATION (Postcode, MAP . . . . )
Number of Guests . .
Age of guests
Entertainment (Band, Puppets . . . options given depend on age/type of party . . )
Date(s) date with alternatives
Food (Buffet, burgers, cold . . . . )
transport (Bu, Limo . . . )

Once these details have been provided, the ETS encapsulates the data provided and sends it to the SIP server. The SIP server analyses the component expressions returned for each data entry by the user and might search on each. In this way, the SIP server can seek out suitable venues using an initial search process and then perform a more complex SIP search which could include:
Filling in web forms—eg for hotels
Searching list of local entertainers (eg in yellow pages) and contacting them appropriately by phone/email etc.

Of the search results obtained, some may be provided immediately to the user, eg Hotel Fawilty Towers can
provide a complete package. Later further “packages”—put together by the search engine—could be sent (by a pre-set time)—with notification to SMS as usual

In addition the search software could explore if a better fit (with the original search request plus user references) can be made by slight changes to the date/location. This could provide a cheaper better venue but perhaps slightly further away.

### Example B 2—Spare Part for Classic Car

Consider where the user wants to buy a specific part, e.g. a petrol pump, for an specific car, e.g. the Alfa GT Junior 1600 1972. The ETS packages the search request and sends it to server. The proxy server knows Alfa parts suppliers already (for example, the proxy server may have built up a database of such common enquiries because car parts are common enough to crawl the web at night for and cache URLs). However, if the SIP proxy server sends a search request containing these specific details and receives a response that none of the suppliers it has already details of can provide this part the SIP proxy server may notify the user that the search may take longer than initially expected. The SIP proxy server may then initiate a full search, resulting in a search engine trawling the web to locate, for example, 2nd hand part suppliers. This result could be returned to the SIP proxy server which may then further interrogate the resulting part suppliers via a suitable medium such as an email request. The Email request may ask for information to be provided in a specific format. The information is then sent to the proxy server in the designated format which enables the SIP proxy server to extract certain information from it. For example, the SIP proxy server could receive a reply which asks if pump is Webber or Morelli. Search engine would not know how to process such a response and so forwards it to the user, for example, by an SMS notification which contains the enquiry. The User may reply he doesn't know how to tell the difference. The proxy server would then process this response by asking this question to an Alfa news group. The proxy server could then forward responses received to the user who may now response with the appropriate level of detail. The proxy server may now forward this response to a search engine which now sends the full request to the news group used as well as the identified supplier, together with details of a user preference such as the users information of his membership of Alfa owners club to ensure the user is quoted a price which includes a 10% discount. The response may be passed on to the user who may select for the proxy server to complete the transaction if this can be done electronically on-line over the internet. Alternatively, if the best price supplier does not accept electronic payment, the search engine could forward this information with the price quoted and generate an alert to indicate this method of payment is not available. Alternatively, the proxy server could process the information and trigger an alert to search for more information about the supplier on the internet. If the results indicate the supplier is a very small dealer and no information about the company is available, the proxy server or search engine may indicate that cheque is not a suitable form for payment and instead set up a third party escrow account to hold money (for example via trusted escrow) and then broker deal. If a week later the replacement water pump then fails and the user wants to repeat the process, the SIP server can use the results from the previous search to repeat the process.

FIG. 6 shows another embodiment of the invention in which a user wishes to purchase some insurance for a motor vehicle. In the specific embodiment shown in FIG. 6, the user preferences are the preferences of the person performing the search, however, it is possible for preferences associated with a key word such as “boss” or another person's name “Joe Bloggs” may be provided where a person such as a personal assistant wanted to locate specific information for another person.

In FIG. 6, in step 60 a user makes request to buy insurance for a vehicle. In step 61, the ETS recognises from the search expression the user has entered that a standard type of purchase search is being requested. The ETS may be able to recognise the type of search by using the certain key words which indicate more popular searches to retrieve a form requesting more information for such searches. The ETS may then provide the user with such a standard form (car, age, garage?. . . ) and the ETS could then corrects any mistakes and adds any relevant information (eg AA member, also has second car (classic) which the ETS is aware from the user's stored preferences) in step 61.

In step 62, the ETS encrypts the expanded search expression into a SIP message which is then sent to the SIP proxy server which passes the message to the proxy server search software SSS.

The proxy server search software SSS consults a number of information sources by: filling out web forms, text to speech calls, emails, etc, using user preferences either provided by the ETS or stored at the proxy server and local information which is specific to the search (step 63).

Step 64—the results come back at different times, each search result being updated to indicate if the optimum result located so far. For a purchase search the optimum criterion will be price unless the user has set a user preference or entered a key word to indicate another overriding optimum criterion. The user is then informed of the cheapest (headline rate) by SMS over (say) next week and sent a key (e.g. a url) to get the full details (Restrictions, excess . . . ) (step 64).

Step 65 indicates how a user can buy automatically by informing the SIP Search Engine at the proxy server to send his credit card and address details to a specific insurance company whose address details have been located by the search and which the search has indicated as providing insurance at a specific cost which takes into account the fact that the user is a member of certain motoring organisations. The insurance company might request proof of no claims and the search engine might send back his old policy number automatically (step 66).

The proxy server may also be able to interrogate one or more of the insurance web-sites located by the search process to determine that if the user were to join a specific organisation then an additional discount may be available.

In one embodiment of the invention the SIP Search Software modifies the terms in a search expression to optimise the purchase price of an item requested by the search expression. In this way, the SIP search software is able to facilitate the purchase of complex items in which a number of parameters can determine the purchase price. The user may indicate such terms can be varied by pre-pending or appending a symbol to the search term that the SIP search software will recognise as indicating a variable search parameter (e.g. the date, the number of people at the party, location in the party example) in a way no person would have time to do. Similarly, for travel to a destination, the user may indicate the destination is fixed but one or more of the time, duration of travel and departure date are flexible. The sever might then perform a search which researches the best rates, offers (in a way that a user would never have time to do) and use that to optimise the prices so that the results returned are progressively cheaper. Other examples where the SSS modifies a search to optimise it could include the SSS negotiating to get trade discounts or certain seats for theatre shows.

In another embodiment of the invention, the SSS may operate directly to bulk buy/pre-book popular items (eg London Show tickets) automatically—knowing (from past info and user info on its data base) that it can sell these items to certain users. By exploiting the database of user preference information, the SSS is able to target advertising mail shots to users who would find such items of interest, and so offer particularly good deals at the last minute as the SSS would be aware of the location of users. For example, if a user is in Cardiff, the SSS may know this by the activity reported by the user's mobile terminal, and so advertise tickets for a theatre show in Cardiff that evening. This targeted advertising based on user preferences and knowledge of a user's current whereabouts is highly advantageous.

The above embodiments of the invention may also incorporate additional information which may be obtained either automatically or on request by the user's client terminal or by the proxy server administering the search. For example, the proxy server may perform a look-up based on the user's SIP identifier to a database record containing the additional information. This additional information may be retrieved and automatically included with the search criteria the user generates.

In some embodiments of the invention, the additional information is confidential or includes a request to obtain information which is confidential. Additional information, in particular confidential information, may be subject to a variety of access controls which may be imposed by the user or by the proxy server or by the data source for the information.

Generally these access controls will be implemented in a manner transparent to the user requesting the search, i.e., the additional information is sent automatically without the user being aware of either the need to provide additional information or the content of the additional information provided. However, in other embodiments the user must authorise the issue of confidential information, for example, by signing a digital certificate authorising a third party to release certain information. The released information is incorporated either directly into the search request or, alternatively, provided on request to any entities meeting certain security criteria which have requested the additional information. Typically, only entities capable of providing more personalised information will issue such a request. The request for additional information can be provided with a response containing generic information. The SIP server may process the generic information and forward it to the user should the user's search request indicate that such information is of interest, alternatively, the SIP server may retain or disregard such information if the search request indicates only specific information is of interest.

The process of incorporating the additional information can be automated in any suitable manner, for example, if the context of the search conforms with one or more criteria, then additional information may be required to be incorporated and appropriate steps taken to provide this information.

The invention thus provides a method of performing a search in which specific information is provided whose context and/or content is dependent on information which is specific to an entity (generally but not necessarily the searcher). One embodiment of this aspect of the invention is shown in FIG. 7, in which in step 70 a searcher issues a search request for some information relating to the search criteria.

In this embodiment, the search request is processed by the SIP search server and forwarded in the manner described hereinabove to various data sources. A data source receiving a request to provide information may determine that the search request comprises a request for information which can be answered at a generic level, but which could be supplemented by more specific information if additional information was provided which identified the entity to whom the information sought related. The data source in this embodiment responds which some general information and requests the additional information it requires in order to provide more specific information (step 71). The proxy server forwards this request to the user who authorises a third party data source (e.g. by providing a signed digital certificate) to provide the requested information (step 72). Step 72 may be performed automatically if the searcher has configured their account with the SIP server appropriately, and this may enable the SIP server to perform the authorisation directly on behalf of the searcher/entity who needs to provide the authorisation.

Returning to FIG. 7, the SIP server forwards the authorisation to the third party data source(s) (step 73). The authorisation enables the third party data sources to provide the requested additional information to the requesting data source. In this embodiment, it is the SIP server which receives the additional information provided by the third party data source and forwards it to the requesting data source so that the requesting data source can provide more information specific to the entity associated with the search request. Typically this information will be encrypted and signed by the issuing body (step 74). The SIP server then forwards this to the data source requesting the additional information (step 75). The additional information is verified by the data source (step 76) and the information is suitably processed (in conjunction with the original search criteria) to provide more specific information as a search result which is then forwarded back to the searcher via the SIP server (step 76).

Those skilled in the art will realise that may variations on the manner in which the information is requested and incorporated into the search request and search results are possible. The invention provides in each case the opportunity for information to be provided which relates to a specific entity (for example, the individual performing the search) which enable data to be returned which relates specifically to the individual.

The invention furthermore provides a means for this information to be incorporated in such a way that the entity performing the search need not be aware of the content of the additional information provided. By enabling confidential information to be provided in a secure manner, it is possible for a user to search for information that is relevant, for example, regarding a medical condition they may have without the user needing to be aware of any specific information related to their condition.

For example, a user could perform a search with criteria based on “treatment for hayfever”. In this case, the proxy server could recognise the context of the search is medical. Additional information, for example, other medication the user is taking or known allergies or reactions to specific medications could then be appended to the search request without the searcher having to explicitly include such information. This enables the user to receive information back which has already taken into account if they react say to a known drug which might otherwise be very suitable for treating hayfever. Similarly, if the user searches for “hayfever treatment for Joe”, the proxy server may use the user's identity to perform a look up for records and determine that an identifier for “Joe” may be required, and ask the searcher to provide an authorisation code before this is incorporated into the search request. Should the user not have authority to include additional information relating to “Joe” the search results returned may indicate that no specific information for Joe was provided, only generic information. In neither case, however, does the user need to know exactly what information is provided.

Alternatively, instead of the context of the search result being recognised and the appropriate additional information appended, the additional information conveyed may be requested by one or more of the data sources which receive the search request which are capable of incorporating the additional information in their response. This may be more appropriate if information is highly sensitive, in which case, for example, the additional information may only be conveyed to secure sites.

One embodiment of a search method according to the invention will now be described which incorporates permissions and security associations that allow limited access to additional information that would not be freely available under the original search.

In this embodiment, the user is seeking financial information such as a loan. Whilst it is possible to go to a money “supersite” and compare rates on a loan for a specific sum (e.g. £5000), the loans offered would be subject to status checks on the user's credit history etc., and the results of those checks would affect the annual percentage rates (i.e., the interest charged) on the loan.

The search method enables the user's credit history to either be included when the user performs a intelligent search or for a bank or other financial site contacted in the process of a search to request the user's credit history. In neither case does the user have to be aware of their credit history. This means that, for example, the information may be provided from a site holding the user's bank details etc, without the user needing to access such information or arrange for it to be sent subsequently. The information is instead retrieved from the user's bank data source or from some other intermediary or from a dedicated data bank and provided either to the site requesting the information or to the user's client terminal or proxy server so that it can be appended to the user's search criteria.

The search requests generated by the invention which are sent out by the proxy server in this embodiment of the invention may be targeted towards specific sites associated with the additional information already held for a user, for example targeting the bank credit card companies with which the searcher has an existing account. This may result in more favorable loan interest rates as such institutions may offer existing customers more favorable rates.

The search could also be quite specific and may be based on a template, for example, the user may request a search with important questions relating to loans: option to pay back early, purpose of loan (can it be added to mortgage—does the searcher have a mortgage?) and so forth.

Those skilled in the art will appreciate that the sites from which data related to the search request is retrieved are not able to provide more specific information unless they are aware of the identity of the searcher (or the party for whom the loan is sought in the case where the searcher is not the recipient of the loan). Thus in one embodiment of the invention two different types of information are retrieved. One type of information is generic—i.e., non-specific to any particular entity or individual (in this example on the loan products/services offered). The other type of information is non-generic, i.e. specific, so that if the identity of the subject to which the generic information should relate can be determined by the data source (the same data source providing the generic information—i.e., in this example the identity of the proposed loan recipient) there will be a second, more personalized, level of information which is provided. This requires, for example an appropriate identifier for the entity for which specific information is to be provided to be presented to the data source. The identifier is either included in the search request issued or it is accessible on demand should a site request such information via the SIP server. The invention enables this second type of information, i.e., the personalized information, to be received when a search is performed and the search criteria or the search sites are able to identify a target recipient of the information or a target recipient to which the information relates.

The advantage of providing personalized information is that it enables the information returned by the search to be presented in a form which enables further action to be taken by the user based on the content of the information returned. For example, if a searcher was to seek out a loan for themselves and received back only information at a generic non-personalised level, should the searcher select a loan they would then need to pass a credit check, this would need to be authenticated by the loan provider, and then the user would need to authenticate they were the recipient of the loan before receiving any money.

The invention enables the user to see and compare real loan information such as the terms and A.P.Rs. and any ancillary benefits or requirements, after they have effectively has the information tailored for their own credit history. Should the confidential information provided on by the loan recipient be considered to be sufficient, all relevant credit-checks may have been performed (for example, if the confidential information provided/requested by a loan site included all relevant financial information required such as bank details, loans, other credit card accounts, saving etc) this means the interest rate and terms offered will reflect the user's credit history and current financial status. The user is then able to take a further action if the information is presented in the right format such as accepting the loan product offered, or purchasing the relevant item (or, for example, some other action such as for a search performed for a medication, the medication may be presented in such a form that it can be purchased or prescribed for a person).

Moreover, should the user select to receive a particular loan, the information provided may remove any need for the user to further authenticate themselves before receiving the money, electronically transferred in a default or designated bank account. This effectively means a user could enter a search criteria “Cheapest loan for £5,000” and in response to the search results then select a loan offered by bank A for three years at an annual percentage rate of 5%, and have the amount electronically transferred to their bank account. Such a seamless banking environment may present risks to the user and various bank institutions may want to impose further checks, however, the invention enables such a facility to be offered in which a true comparison can be made of the terms each financial institution offers.

Where a search is requested with a view to the information retrieved being specifically related to a third party, the third party will need to provide the searcher with an identifier or access code to enable their personal information to be specifically entered. Such an identifier may be provided with a finite lifetime as a security measure. If the information requested is specific to the searcher, the identifier may be associated with the searcher logging into the search application or by the searcher specifically ensuring their own identifier is contained within the search criteria using some appropriate means.

In one embodiment of the invention, the personalised information provided by the search method enables medical subject matter searches to be performed generally by third parties for patients and for the patients themselves.

Whilst the term “identifier” has been used able, any security mechanism which enables access to the information relevant to the search may be used. For example, to enable the specific information to be accessed, the searcher or SIP server can embed a security mechanism allowing a third party access to information in relation to the search.

In the case of the loan applicant this might be (for example) permission to check his/her credit rating at their bank. This could either be generated by the applicant or by the SIP search engine (which would have a secure relationship with the applicant). The SIP search engine would look generally for good rates (as happens) now, narrow this down using the searchers profile (as would happen with the existing SIP search) and would then apply for a specific rate and terms quotation using the additional security mechanisms to allow third party access (i.e. the loan provider) or to access the information in such a way that it is trusted by the loan provider.

One embodiment of the invention uses digital certificates. In this embodiment, the SIP server sends a credit reference check to the searcher. The searcher digitally signs the credit reference check with a certificate issued by their bank—the SIP server would send the signed request to the bank who would check their records and provide a credit reference (which could be encrypted) and this would be forwarded to the loan provider who could then check that it had come from the bank and related to the original applicant. This would allow confidential information to pass from the bank to the loan provider without identifying the individual and without the applicant needing to wait for traditional credit clearance.

FIGS. 8 and 9 of the accompanying drawings show schematically how this embodiment might be implemented and some of the method steps involved respectively.

In FIG. 8, an embodiment of the invention is shown in which the SIP search method of the invention is used to retrieve data when the user wishes to perform a search for a loan and to receive back search results which are personally relevant to the user (the searcher).

In FIG. 8 user terminal 80 supports first search software module 81 which is arranged to offer an appropriate search interface to a searcher operating user terminal 80. The searcher uses software module 81 to generate a request for information on loans and the cheapest interest rates. In the embodiment shown in FIG. 8, the search software module 81 processes the search request and forwards (step A) this on via SIP user agent 82 to the SIP proxy server 84.

The SIP proxy server 84 supports search software module 85 which generates a suitable search based on the search request provided by the SIP client terminal 80. SIP user agent(s) 88 implement the search by seeking to retrieve information over a communications network (not shown) from various data sources (step B).

Data source 90 provides a platform to support the third SIP software module 66 which acts as an interface for the SIP user agent 88 to enable the received message from the proxy SIP server 84 to be processed to determine if information conforming with the user's search request can be provided. Data source 90 (“Loans Company”) processes the received search request and response with some generic information, such as their typical loan interest rates (step C) and a request for more specific information in the form of either the identity or credit history or both of the intended loan applicant.

In this embodiment, the receipt of a request for more specific information causes the SIP proxy server 84 to request more information. The SIP Proxy Server then repackages this request and forwards it to either the user (step D) or to a credit reference information source (such as the users bank—if this is known by the server—i.e., proceeding directly to step F).

The user terminal 80 which provides a platform for SIP software module 81 responds to the receipt (step E) of this information request by signing the server's request using the security association already established with the credit reference provider (in this case the bank) using the digital certificate 83 and user's private key (which could be established when the user set up their (on-line) account). The server then requests (step F) the credit information required to support the loan quotes—which the bank then returns (step G).

This information may be encrypted, so that only the end user may unlock it (in which case the server sends it to the user) or it may be encrypted in such a way that only approved financial institutions may unlock it (in which case it is locked with either a general public key, to which the institutions have the private key, or a specific key for the requesting institution.

The server may simply pass on (step H) the information from the bank or it may send it to the user for unlocking (or even unlock the information itself if the user has a strong security association with the SIP server) and perform further processing on the information (not shown). This processing might include the removal of the applicant's identity or irrelevant information. In addition to this processed information (which might be a sub set of the information sent out by the bank) a full version of the bank information is signed and encrypted and included within the information sent to the loan company. The loan company can then send (not shown in FIG. 8) the information they have received and the encrypted full version back to the bank which will then verify that the information sent from the user or SIP server had not been tampered with and that it is complete in the areas that are required. The bank can then confirm that the information is correct and relates to the applicant—without the loan company necessarily knowing the applicants name or getting access to more information than was strictly necessary.

The financial body is then able to determine the actual values of certain interest rates, and whether they could in fact offer a specific loan product and any related services and the actual terms of the loan rather than just provide information describing their services and interest rates generically.

The proxy server 84 processes this additional information (for example to check it conforms with the original search criteria of the user and/or any other preferences of the user) before it is provided with any other search results back to the user (step 1). The information which is reliant on the credit history and other confidential information may be formatted by the SIP proxy server 84 in such a way that the user can easily accept the terms of the loan offered.

FIG. 9 summaries some of the step in the above embodiment. The searcher generates a search request (step 91) which is forwarded via a SIP server to a loan supplier. The loan supplier then offers some general rate information and requests some more specific information (for example the identity and credit history of the intended loan applicant (step 92)). The SIP server then may query the searcher as to the intended loan applicant and assuming this is the searcher; then requests the searcher to digitally sign a request to retrieve the searcher's financial information from their bank account. The user signs the request using the previously generated public/private key pair and associated with the digital certificate (which has been previously issued by their bank) (step 93).

The SIP server then sends the signed request (which includes details required for the loan) to the searcher's bank to provide the necessary information to give to the loan supplier (step 94). The searcher's bank then responds with the information (preferably in an encrypted and signed format) (step 95). This information is then forwarded to the loan supplier who then processes the received information to verify the credit history of the intended loan applicant (step 96). The loan supplier then responds with specific information, for example, to include the terms of the loan they are prepared to offer (or an indication they cannot respond based on the user's credit history) etc (step 98).

Those skilled in the art will appreciate that the principle can be further extended to cover the generic exchange of information related to searching using all kinds of “contingent” and supplementary information that might need to be exchanged by remote parties to assist or enhance a search but requires the authorization/authentication (in its widest sense).

In the case where a search can only return generic information unless access to medical records is provided, for example, if a searcher searches for an insurance product there will be generic information available but specific prices depend on the medical history of the party to be insured. In this case the SIP search engine will need to arrange for the insurance company to access the medical record of the applicant.

The level of access to confidential information may vary according to either the sensitivity of the party and/or the security status of the receiving site. For example, a series of access controls may be implemented and clearance governed by rules according to the nature of the party requesting the confidential information. Examples of different categories for medical health are indicated below. These categories could be automatically created by the body that creates the confidential information, or the SIP server may restrict access or the individual to whom the information relates may restrict access:

Full access—GP and health service

Summary—insurance companies, employer (with user consent)

Data protection summary—individuals (when authenticated)

Each group is able to authorize third parties to access their level of information or to create a sub category for specific purposes (such as getting life cover . . ) In this case the role of the SIP server is to mediate the information exchange between the parties whilst maintaining privacy and security.

Those skilled in the art will appreciate that notifications of search results may comprise in some instances the entire search result or a reduced data set (for example, just the title and artist of an audio file and not the audio file itself, or a still image of a video). The notification may be delivered electronically by any suitable means and may comprise an email message, sms message, a telephone call message (generated using suitable voice generation technology) or a multi-media mobile telephone type message.

1-56. (canceled)

57. A method of retrieving data associated with an item searched for using a distributed computer system, the retrieved data enabling an further action comprising the purchase of the item by a user associated with a permanent user identity, the method comprising:
generating a search request for the item at a user terminal during an initial search session, the search request being associated with said user identity;
modifying the search request to indicate at least one user preference associated with said user identity;
forwarding the search request to a server adapted to retrieve data from the distributed computer system,
retrieving the data from the distributed computer system;
associating the retrieved data with said permanent user identity;
providing a search result comprising said retrieved data associated with said user identity to a user terminal selected in accordance with a predetermined user preference dependent on the extent to which the search result conforms with the search request, wherein said retrieved data comprises an item conforming to the search criteria of the search request, and
performing said further action on said retrieved data in accordance with said at least one said user preference, wherein said further action comprises the purchase of the item at a cost informed by the data retrieved by the search result,
wherein the association of said search result with said permanent user identifier enables said search result data to be retrieved by said user after the initial search session has terminated.

58. A method as claimed in claim 57, wherein a user preference includes financial information personal to the user and another user preference indicates at least one criteria which a search result must conform which initiates said further action, and said further action comprises the automatic purchase of the item prior to the user being informed of the search result.

59. A method as claimed in claim 57, in which the search result is provided in a medium and format selected by the user for a user terminal to which the search result is to be forwarded.

60. A method as claimed in claim 57, wherein the unique user identity is a session initiation protocol (SIP) user identity and said item is purchased at a time when the user is not in communication with the proxy server.

61. A method as claimed in 57, wherein the data includes an item and associated cost information and the distributed computer system comprises at least one user terminal capable of communicating with a proxy server, the proxy server being capable of communicating with at least one other server capable of retrieving information from the distributed computer system, the user terminal being adapted to be operable by a user who is registered with the proxy server with an identifier for the user, the identifier being associated with one or more static or dynamic addresses, the user identifier being further associated with a set of user preferences, wherein said step of generating a search request at said user terminal comprises:
indicating at least one search criterion to be met by the data to be retrieved; and sending a search request message encapsulating the search request to the proxy server;
wherein said step of modifying the search request incorporates the user preferences and associates the search request message with the identifier of the user;
wherein said step of forwarding the search request comprises:
forwarding the modified search request message and the identifier from the proxy server to at least one search server arranged to process the received search request message;
wherein said step of retrieving data comprises performing a search according to the encapsulated search request;
wherein said steps of associating the retrieved data and providing a search result comprise sending a search result containing some information dependent on the identifier for the user encapsulated in a search result message to the proxy server; and wherein said step of performing said action further comprises said proxy server performing the steps of:
de-encapsulating the search result message;
processing the search result according to the set of user preferences;
selecting one of said at least one user terminals according to the set of user preferences; and
sending an search result message encapsulating the processed search result to said at least one selected user terminal.

62. A method as claimed in claim 61, further including the step of the proxy server purchasing the item at the cost indicated by the search result and modifying the search result to indicate the item has been already purchased, if at least one predetermined user preference indicates personal financial information of the user which enables the purchase transaction to be completed by the proxy server, the proxy server being configured to automatically purchase an item at a designated cost if at least one user preference indicates that an automatic purchase can occur if the search result meets at least one predetermined search criterion.

63. A method as claimed in 57, wherein the distributed computer system supports the session initiation protocol (SIP), and wherein the user terminal is a SIP registered terminal, the proxy server is a SIP proxy server, and the user is registered at the proxy server with a unique SIP address.

64. A method as claimed in claim 63, wherein the search result message is a SIP message which is sent to the user at an address determined by the SIP proxy server to be the current location of the user who requested the search.

65. A method as claimed in claim 64, wherein the identifier comprises the user's registered SIP identity and the search result SIP message is sent to a plurality of addresses associated with the user's registered SIP identity.

66. A method as claimed in claim 63, wherein the search result SIP message is sent to an address associated with a different user terminal than the user terminal operated by the user to send the search request to the SIP proxy server.

67. A method as claimed in claim 57, wherein the user terminal is a mobile device.

68. A method as claimed in claim 57, wherein the set of user preferences comprises a formatting user preference which indicates how the search result should be formatted.

69. A method as claimed in claim 57, wherein the set of user preferences comprises a plurality of formatting user preferences, each formatting user preference being associated with a type of user terminal.

70. A method as claimed in 57, wherein the method further comprises the step of the proxy server modifying the set of at least one search criterion according to said set of user preferences.

71. A method as claimed in 57, wherein at least one user preference indicates a scheme to which the user has subscribed which may modify the cost of an item returned by the search.

72. A method as claimed in 57, wherein the method further comprises the step of the proxy server modifying the search result according to a set of user preferences.

73. A method as claimed in claim 72, wherein the proxy server software modifies the search result by modifying the cost of an item returned according to a pricing scheme to which the user has subscribed.

74. A method as claimed in claim 72, wherein the proxy server software modifies the search result by modifying the cost of an item returned according to a pricing scheme provided by the proxy server software.

75. A method as claimed in 57, wherein the at least one search server to which said search request message is forwarded to by the proxy server is determined by the proxy server in accordance with said set of at least one user preferences.

76. A method as claimed in 57, wherein the proxy server modifies the search result received to identify an address to which the search request can be forwarded to in the form of an electronic email.

77. A method as claimed in 57, wherein the proxy server processes the returned search result to remove at least one result which is indicated by at least one user preference as not relevant to the user's listed interests.

78. A method as claimed in 57, wherein the proxy server processes the returned search result to modify any returned cost value for an item indicated by the search according to a discount scheme to which the identity of the user is associated.

79. A method as claimed in 57, wherein the proxy server processes the search result to prioritise the delivery of at least one item listed by the search result to the user in accordance with the extent to which said at least one item conforms with the set of at least one search criterion.

80. A method as claimed in claim 79, wherein the proxy server alerts the user to a search result by encapsulating the search result in a small message service SMS message which is sent to the user over a communications network.

81. A method as claimed in 57, wherein the search request is generated by the user terminal modifying a previously stored search request in accordance with an updated set of at least one search criterion.

82. A method as claimed in 57, wherein the set of at least one user preferences specifies a maximum time limit for the search results to be generated.

83. A method as claimed in 57, wherein the distributed computer system is connected over a communications network.

84. A method as claimed in 57, wherein the session during which software provided on the user terminal interfaces with software provided on the proxy server to send the proxy server the search request message is terminated when the proxy server sends the search result message to the user.

85. A user terminal arranged to be operable by a user for use in generating a search request according to the method of claim 57.

86. A proxy server arranged to receive a search request message from a user terminal as claimed in claim 85, the proxy server being arranged to be used in a method of:
generating a search request for the item at a user terminal during an initial search session, the search request being associated with said user identity;
modifying the search request to indicate at least one user preference associated with said user identity;
forwarding the search request to a server adapted to retrieve data from the distributed computer system,
retrieving the data from the distributed computer system;
associating the retrieved data with said permanent user identity;
providing a search result comprising said retrieved data associated with said user identity to a user terminal selected in accordance with a predetermined user preference dependent on the extent to which the search result conforms with the search request, wherein said retrieved data comprises an item conforming to the search criteria of the search request, and
performing said further action on said retrieved data in accordance with said at least one said user preference, wherein said further action comprises the purchase of the item at a cost informed by the data retrieved by the search result,
wherein the association of said search result with said permanent user identifier enables said search result data to be retrieved by said user after the initial search session has terminated.

87. A suite of computer programs arranged to implement a method according to claim 57, the suite of computers being provided on the distributed computer system.

88. A signal carrying a search request generated by a method according to claim 57 over a communications network comprising the distributed computer system.

89. A signal carrying a search result generated by a method according to claim 57 communications network comprising the distributed computer system.

90. A communications network arranged to communicate a signal according to claim 88

91. A method as claimed in claim 57, wherein the method further provides steps enabling the provision of an item at a discounted cost to a user over a communication network comprising a distributed computer system, the method comprising performing a search for the item and associated cost information according to claim 57, wherein the proxy server automatically provides the server software at a site indicated in the search result as able to provide the item requested by the search request with information derived from the user's preferences, the information including:
sufficient financial information to enable the user to purchase the item;
sufficient address information to enable the item to be sent to an address designated by the user.

92. A method as claimed in claim 91, wherein the items to be purchased are sent to a postal address.

93. A method as claimed in claim 91, wherein a discount purchase scheme is provided, the method further comprising the step of:
discounting the cost of the item returned by the search by a predetermined amount in accordance with a discount rule determined by the proxy server.

94. A method as claimed in claim 93, wherein, when an item is purchased, a user preference is updated to reflect a predetermined number of points which can be indicated by the user in at least one future search request for an item and associated cost information.

95. A method as claimed in claim 93, wherein, when an item is purchased, a user preference is updated to reflect a predetermined number of points which can be indicated by the user in at least one future search request for an item and associated cost information, wherein the points indicated by the user preference generate a discount in the cost of an item indicated by a search result which at least partially conforms with the future search request.
